(19) United States
(12) Patent Application Publication
(10) Pub. No.: US 2025/0252700 A1
(43) Pub. Date: Aug. 7, 2025

(54) Wearable Device Including An Artificially Intelligent Assistant For Generating Responses Based On Shared Contextual Data, And Systems And Methods Of Use Thereof

(71) Applicant: Meta Platforms Technologies, LLC, Menlo Park, CA (US)

(72) Inventors: Ashish Vishwanath Shenoy, Bothell, WA (US); Yichao Lu, Seattle, WA (US); Srihari Jayakumar, Sunnyvale, CA (US); Debojeet Chatterjee, San Jose, CA (US); Mohsen Moslehpour, San Jose, CA (US); Pierce I-Jen Chuang, Sunnyvale, CA (US); Abhay Suresh Harpale, San Ramon, CA (US); Vikas Seshagiri Rao Bhardwaj, Seattle, WA (US); Anuj Kumar, Kirkland, WA (US)

(21) Appl. No.: 19/045,512

(22) Filed: Feb. 4, 2025

Related U.S. Application Data
(63) Continuation-in-part of application No. 18/796,252, filed on Aug. 6, 2024.
(60) Provisional application No. 63/551,062, filed on Feb. 7, 2024.
(60) Provisional application No. 63/556,340, filed on Feb. 21, 2024.

(51) Int. Cl. G06V 10/22; G02B 27/01; G06T 3/40

(52) U.S. Cl. CPC G06V 10/235; G02B 27/017; G06T 3/40

(57) ABSTRACT

System and method including an artificially intelligent assistant are described. An example method includes, in response to a user input initiating an artificially intelligent (AI) assistant, capturing contextual data including one or more of image data and audio data. The method includes generating, based on the contextual data, user query data including a user query and a portion of the contextual data. The method includes determining, using an AI assistant model that receives the user query data, a user prompt based on, at least the user query and the portion of the contextual data, and generating, by the AI assistant model, a response to the user prompt. The method further includes causing presentation of the response to the user prompt at a head-wearable device.

### CROSS-REFERENCE TO RELATED APPLICATIONS

This application is a continuation-in-part of U.S. patent application Ser. No. 18/796,252, filed Aug. 6, 2024, entitled “Wearable Device Including An Artificially Intelligent Assistant For Generating Responses To User Requests, And Systems And Methods Of Use Thereof,” which is incorporated herein by reference.

This application claims priority to U.S. Prov. App. No. 63/551,062, filed on Feb. 7, 2024, and entitled “Wearable Device Virtual Assistant For Answering User Queries To Captured Image Data, And Systems And Methods Of Use Thereof” and U.S. Prov. App. No. 63/556,340, filed on Feb. 21, 2024, and entitled “Wearable Device Virtual Assistant For Answering User Queries To Captured Image Data, And Systems And Methods Of Use Thereof,” each of which is incorporated herein by reference.

### TECHNICAL FIELD

This relates generally to a wearable device including an artificially intelligent assistant, including but not limited to techniques for interacting with the artificially intelligent assistant using a multimodal large language model.

### BACKGROUND

Existing solution for screen-text recognition and use of multimodal large language model require sending large images (e.g., full-resolution images) to a remote server. Sending images to a remote server can increase latency and utilize a large amount of computational resources. Alternative, sending smaller images (e.g., less than full-resolution images) to a remote server for screen-text recognition and use of multimodal large language model decrease accuracy while decreasing latency. As such, existing solution decrease a user's experience through either low accuracy results and/or increased wait times.

As such, there is a need to address one or more of the above-identified challenges. A brief summary of solutions to the issues noted above are described below.

### SUMMARY

The methods, systems, and devices described herein allow for use of an artificially intelligent (AI) assistant at wearable devices or other electronic devices with limited computational resources or other hardware constraints. The methods, systems, and devices disclosed herein distribute one or more operations performed at the wearable device to reduce latency, power consumption, and use of computations resources. In some embodiments, the methods, systems, and devices described herein reduce an average end to end latency (e.g., to less than or equal to 5 seconds (including photo capture, image transfer, on-device scene text recognition execution and server-side multimodal large language model execution). In some embodiments, the on-device scene text recognition models have a reduced size (e.g., a total size less than or equal to 20 MB, a peak memory usage of less than or equal to 200 MB, and an average latency of less than or equal to 1 second). The disclosed egocentric scene text recognition model has high accuracy (e.g., a word error rate of 14.6% (compared with 53% WER from a non-egocentric baseline).

An example AI assistant system is described herein. The AI assistant system is part of a wearable device including an imaging device, a microphone, one or more sensors, a speaker, and a display. The wearable device, in response to initiation of an AI assistant, captures contextual data. The contextual data includes one or more of image data, audio data, and/or sensor data. The wearable device determines, based on the contextual data, a contextual cue, and provides a portion of the contextual data and a portion of the contextual cue to the AI assistant. The wearable device determines, by the AI assistant, a user request based on the portion of the contextual data and the contextual cue, and receives a response to the user request. The response is generated using a machine-learning model. The machine-learning model can be a multimodal large language model (MM-LLM), a lightweight MM-LLM, and/or another machine-learning model. The wearable device further causes presentation the response.

Another example AI assistant system is described herein. This example AI assistant system includes a wearable device and a server. The wearable device includes an imaging device, a microphone, a speaker, a display, and one or more first programs stored in first memory and configured to be executed by one or more first processors. The one or more first programs include instructions for, in response to a user input initiating an AI assistant, capturing, via the imaging device and/or the microphone, image data and/or audio data. The one or more first programs further include instructions for, in response to capturing the image data and/or the audio data, compressing the image data to generate compressed image data, determining, based on the image data, at least text and text locations, and determining, based on the audio data, a user query. The compressed image data has a second resolution less than a first resolution of the image data. The one or more first programs further include instructions for providing, at least, the compressed image data, the text, the text location, and the user query to the server communicatively coupled with the wearable device. The server includes one or more second programs stored in second memory and configured to be executed by one or more second processors. The one or more second programs including instructions for, in response to receiving, from the wearable device, the compressed image data, the text, the text location, and the user query, generating, based on at least the text, the text locations, and the user query, a prompt; providing the compressed image data and the prompt to a machine learning model that is configured to determine a response to the prompt; and providing the response to the prompt to the wearable device for presentation at the wearable device.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality headset (e.g., a mixed-reality (MR) headset or an augmented-reality (AR) headset as two examples), a wrist-wearable device, an intermediary processing device, a smart textile-based garment, etc.). For instance, the instructions can be stored on an AR headset or can be stored on a combination of an AR headset and an associated input device (e.g., a wrist-wearable device) such that instructions for causing detection of input operations can be performed at the input device and instructions for causing changes to a displayed user interface in response to those input operations can be performed at the AR headset. The devices and systems described herein can be configured to be used in conjunction with methods and operations for providing an extended-reality experience. The methods and operations for providing an extended-reality experience can be stored on a non-transitory computer-readable storage medium.

The devices and/or systems described herein can be configured to include instructions that cause performance of methods and operations associated with the presentation and/or interaction with an extended-reality. These methods and operations can be stored on a non-transitory computer-readable storage medium of a device or a system. It is also noted the devices and systems described herein can be part of a larger overarching system that include multiple devices. A non-exhaustive of list of electronic devices that can either alone or in combination (e.g., a system) include instructions that cause performance of methods and operations associated with the presentation and/or interaction with an extended-reality include: an extended-reality headset (e.g., a mixed-reality (MR) headset or an augmented-reality (AR) headset as two examples), a wrist-wearable device, an intermediary processing device, a smart textile-based garment, etc. For example, when a XR headset is described as, it is understood that the XR headset can be in communication with one or more other devices (e.g., a wrist-wearable device, a server, intermediary processing device, etc.) which in together can include instructions for performing methods and operations associated with the presentation and/or interaction with an extended-reality (i.e., the XR headset would be part of a system that includes one or more additional device). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1F illustrate a head-wearable device including an artificially intelligent assistant, in accordance with some embodiments.

FIGS. 2A-2C illustrate adaptable responses provided by the artificially intelligent assistant, in accordance with some embodiments.

FIGS. 3A-3E illustrates example interactions using an AI assistant included in a head-wearable device, in accordance with some embodiments.

FIG. 4 illustrates an example AI assistant system for providing a responses to a user request via a wearable device, in accordance with some embodiments.

FIGS. 5A and 5B illustrate outputs of the scene-text recognition module, in accordance with some embodiments.

FIG. 6A illustrates a method of exporting a module for on-device implementation, in accordance with some embodiments.

FIG. 6B illustrates an example system for providing AI assistance on conversations, in accordance with some embodiments.

FIG. 7 illustrates a system for recommending follow-up actions, in accordance with some embodiments.

FIG. 8 illustrates example training of a follow-up action recommendation system, in accordance with some embodiments.

FIG. 9 illustrates example inputs to a follow-up action recommendation system, in accordance with some embodiments.

FIGS. 10A-10D illustrate a follow-up action recommendation system included on a wearable device, in accordance with some embodiments.

FIG. 11 illustrates example follow-up actions, in accordance with some embodiments.

FIG. 12 illustrates natural language processing system performed on a wearable device, in accordance with some embodiments.

FIG. 13 illustrates an example natural language understanding system, in accordance with some embodiments.

FIG. 14 illustrates an example on-device natural language understanding system, in accordance with some embodiments.

FIGS. 15A and 15B illustrates a flow diagram method of generating a response to a user request using an artificially intelligent assistant, in accordance with some embodiments.

FIGS. 16A, 16B, 16C-1, and 16C-2, illustrate example XR systems that include AR and MR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XR) such as mixed-reality (MR) and augmented-reality (AR) systems. Mixed-realities and augmented-realities, as described herein, are any superimposed functionality and/or sensory-detectable presentation provided by a mixed-reality and augmented-reality systems within a user's physical surroundings. Such mixed-realities can include and/or represent virtual realities and virtual realities in which at least some aspects of the surrounding environment are reconstructed within the virtual environment (e.g., displaying virtual reconstructions of physical objects in a physical environment to avoid the user colliding with the physical objects in a surrounding physical environment). In the case of mixed-realities, the surrounding environment that is presented to via a display is captured via one or more sensors configured to capture the surrounding environment (e.g., a camera sensor, Time of flight (ToF) sensor). While a wearer of a mixed-reality headset can see the surrounding environment in full detail, they are seeing a reconstruction of the environment reproduced using data from the one or more sensors (i.e., the physical objects are not directly viewed by the user). A MR headset can also forgo displaying reconstructions of objects in the physical environment, thereby providing a user with an entirely virtual reality (VR) experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR headset. Throughout this application the term extended reality (XR) is used as a catchall term to cover both augmented realities and mixed realities. In addition, this application also uses, at times, head-wearable device or headset device as a catchall term that covers extended-reality headsets such as augmented-reality headsets and mixed-reality headsets.

As alluded to above a MR environment, as described herein, can include, but is not limited to, VR environments can, include non-immersive, semi-immersive, and fully immersive VR environments. As also alluded to above, AR environments can include marker-based augmented-reality environments, markerless augmented-reality environments, location-based augmented-reality environments, and projection-based augmented-reality environments. The above descriptions are not exhaustive and any other environment that allows for intentional environmental lighting to pass through to the user would fall within the scope of augmented-reality and any other environment that does not allow for intentional environmental lighting to pass through to the user would fall within the scope of a mixed-reality.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing API providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU) s of a wrist-wearable device, and/or one or more sensors included in a smart textile wearable device) and/or detected via image data captured by an imaging device of a wearable device (e.g., a camera of a head-wearable device, an external tracking camera setup in the surrounding environment, etc.)). In-air means, can mean that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit (IMU), capacitive sensors, strain sensors, etc.) detected by a wearable device worn by the user and/or other electronic devices in the user's possession (e.g., smartphones, laptops, imaging devices, intermediary devices, and/or other devices described herein).

The input modalities as alluded to above can be varied and dependent on a user experience. For example, in an interaction in which a wrist-wearable device is used, a user can provide inputs using in-air or surface contact gestures that are detected using neuromuscular signal sensors of the wrist-wearable. In the event that wrist-wearable device is not used, alternative and entirely interchangeable input modalities can be used instead, such as camera(s) located on the headset or elsewhere to detect in-air or surface contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

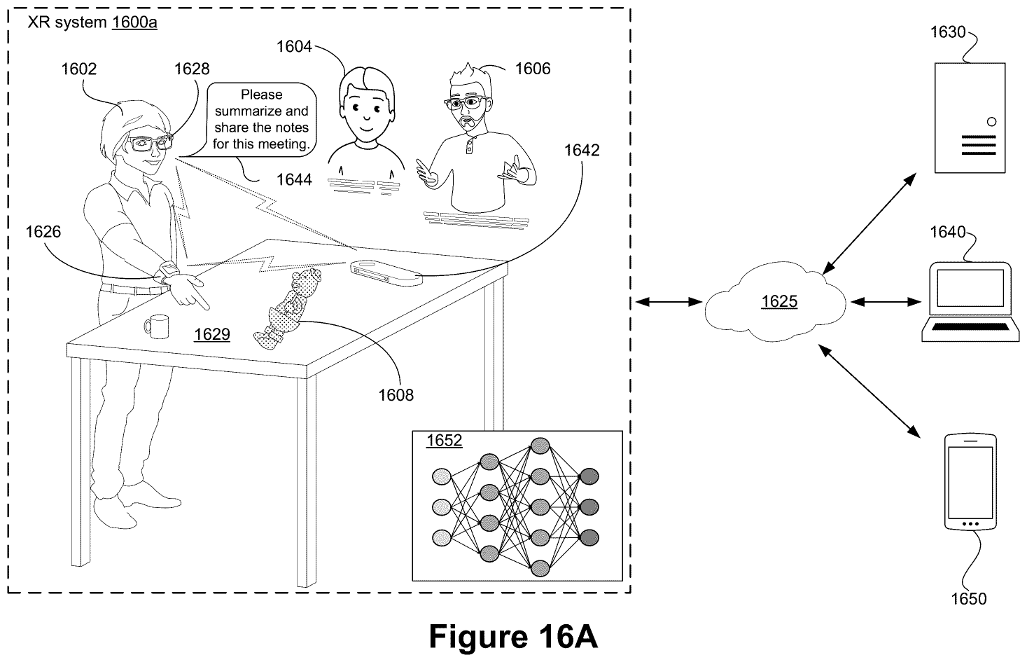

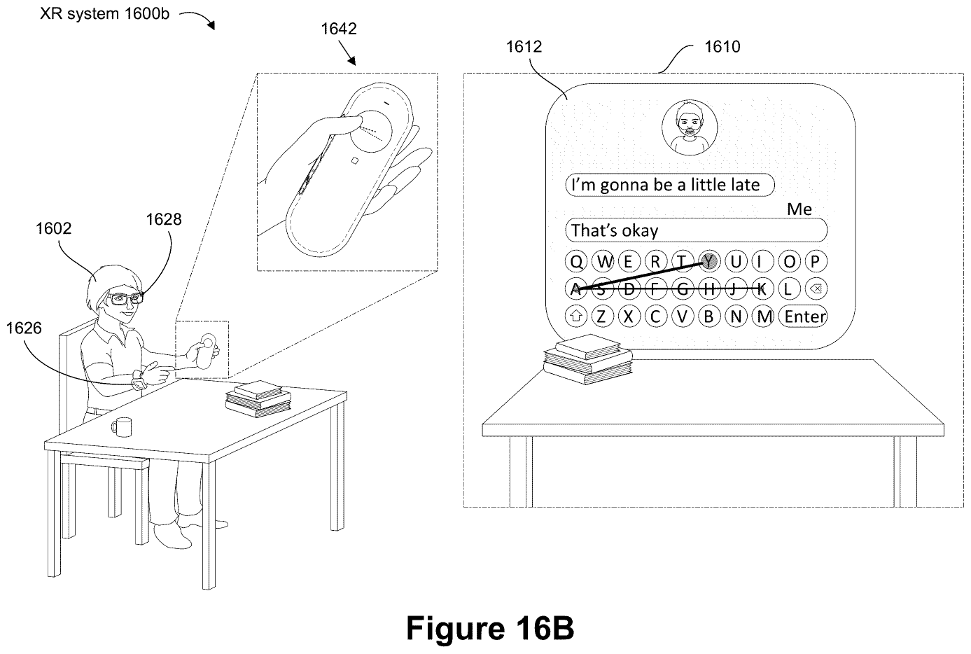

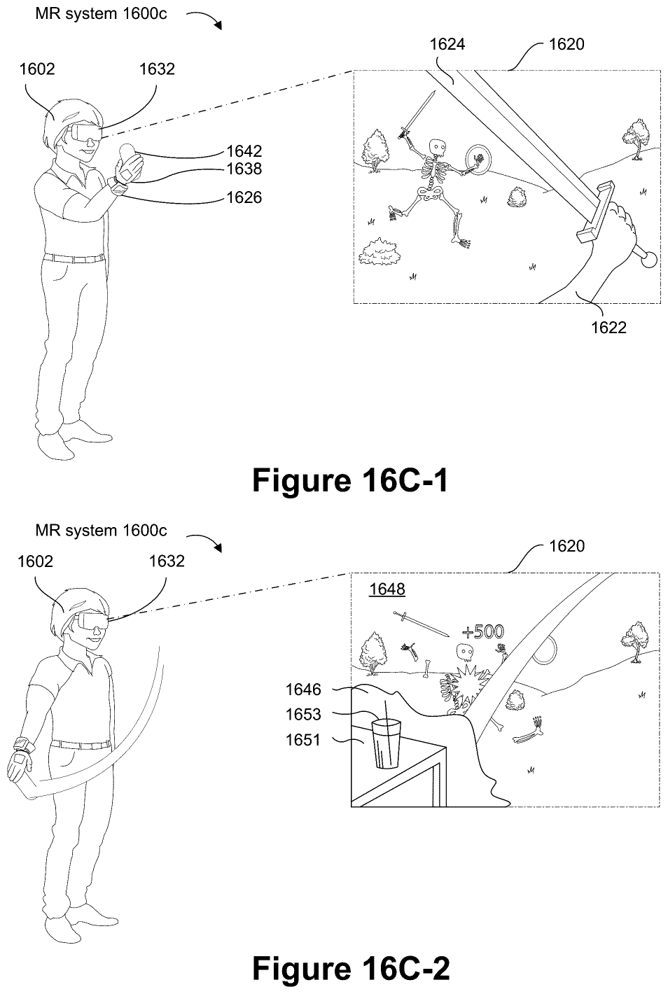

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (e.g. HIPD 1642; FIG. 16A), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a SLAM camera(s)); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors), and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogram (ECG or EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) AR and MR applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

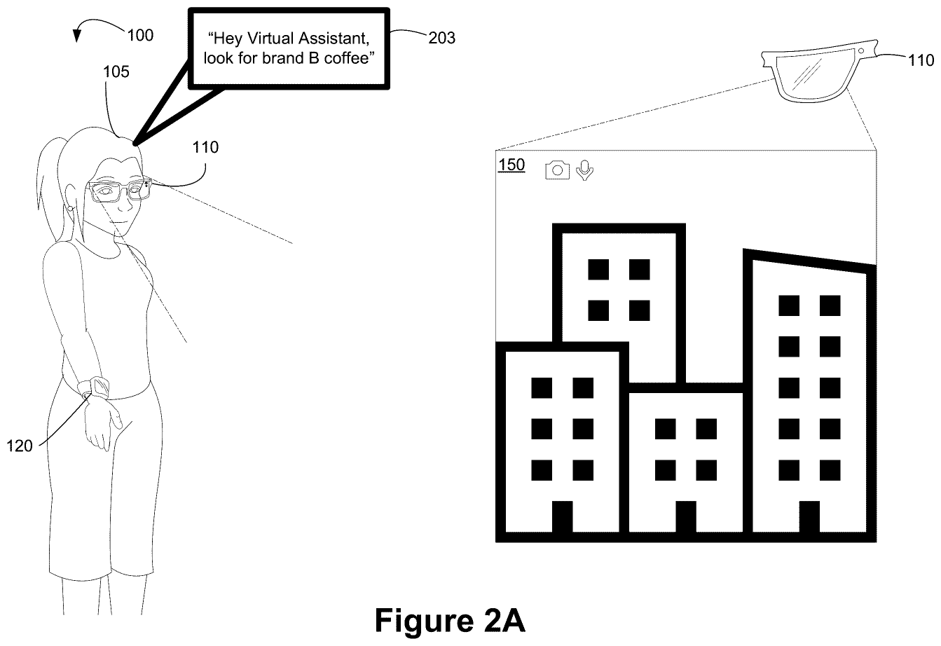

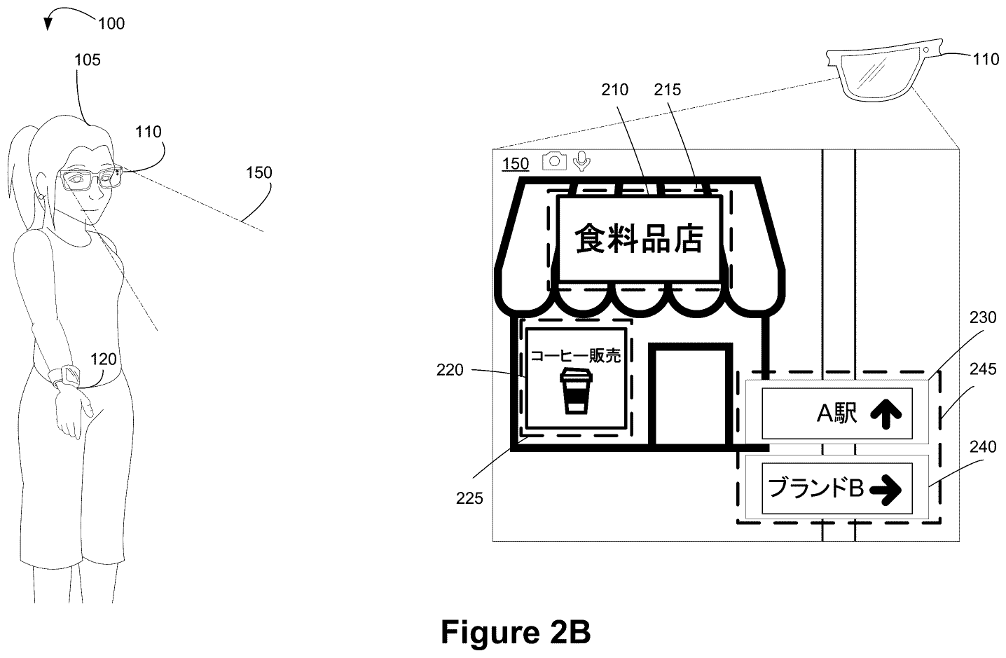

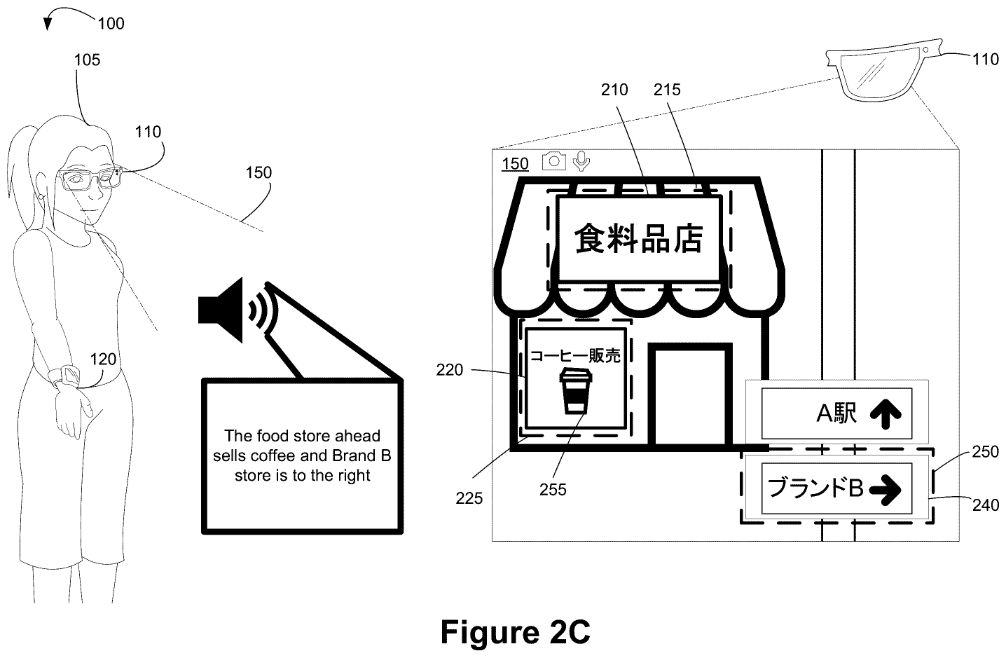

The artificially intelligent (AI) assistant systems described herein allow wearable devices (or other electronic device with limited computational resources and/or other hardware constraints) to perform on-device processing (e.g., egocentric scene-text recognition) and enable multimodal assistants on the wearable devices. In some embodiments, the one or more operations are sent to a server or other device (e.g., smart phone, computer, wrist-wearable device, head-wearable device) to perform the off-device processing to save processing power at the wearable device. On-device modules (also referred to as on-device components), in some embodiments, means modules and/or components stored or included locally on a particular device (e.g., stored on a head-wearable device 110, wrist-wearable device 120, an HIPD 1642, a mobile device 1650, etc.; FIGS. 16A-16C-2). Off-device modules (also referred to as off-device components), in some embodiments, means modules and/or components stored or included on a remote device (e.g., on a server 1630, a computer 1640, an HIPD 1642, etc.).

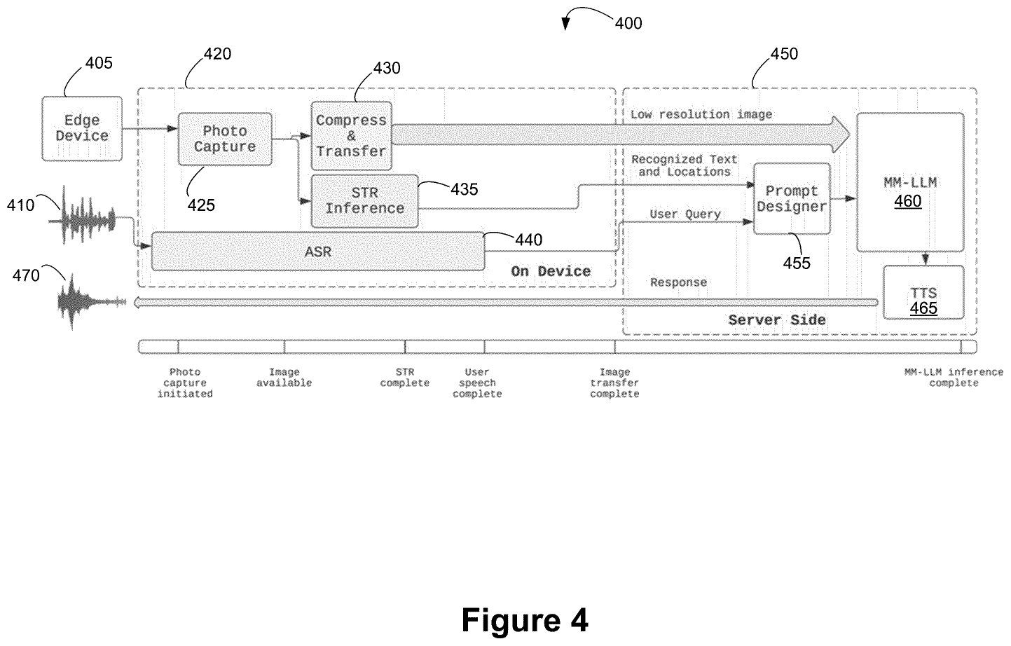

An example AI assistant system described herein can utilize an end-to-end (E2E) multimodal assistant system with text understanding capabilities, and an on-device scene text recognition pipeline with a set of models for region of interest detection, text detection, text recognition, and reading order reconstruction. The on-device scene text recognition pipeline detection and/or recognition achieves high quality outputs (e.g., a word error rate (WER) of 14.6%) at a low computation cost (e.g., a latency of 0.9 s or less, a peak runtime memory of 200 Mb or less, a power usage of 0.4 mwh or less). The region of interest detection model, described below in reference to FIG. 4, allows an on-device scene text recognition model to focus on the area of interest and thus reduce the computational overhead. The example AI assistant system is configured to improve the effectiveness and efficiency of multimodal large language models (MM-LLMs) and scene text recognition systems on a device, such as a wearable device. The example AI assistant system can achieve high quality, low latency, and minimum hardware resource usage through careful placement of components on-device or off-device (e.g., on-cloud).

### Example Wearable Devices Including an Artificially Intelligent Assistant for Exploring the Real World

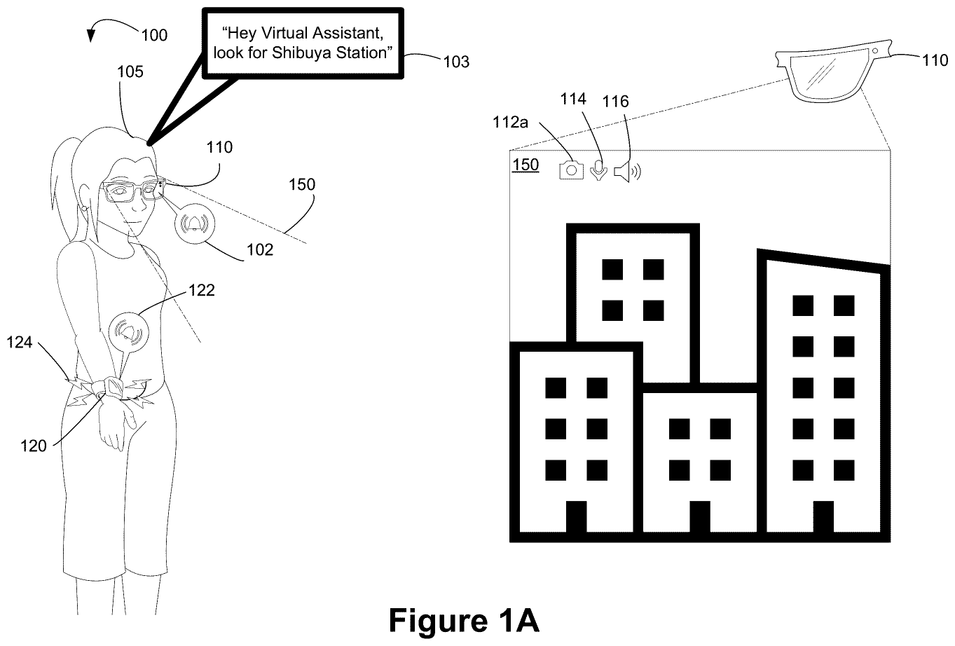

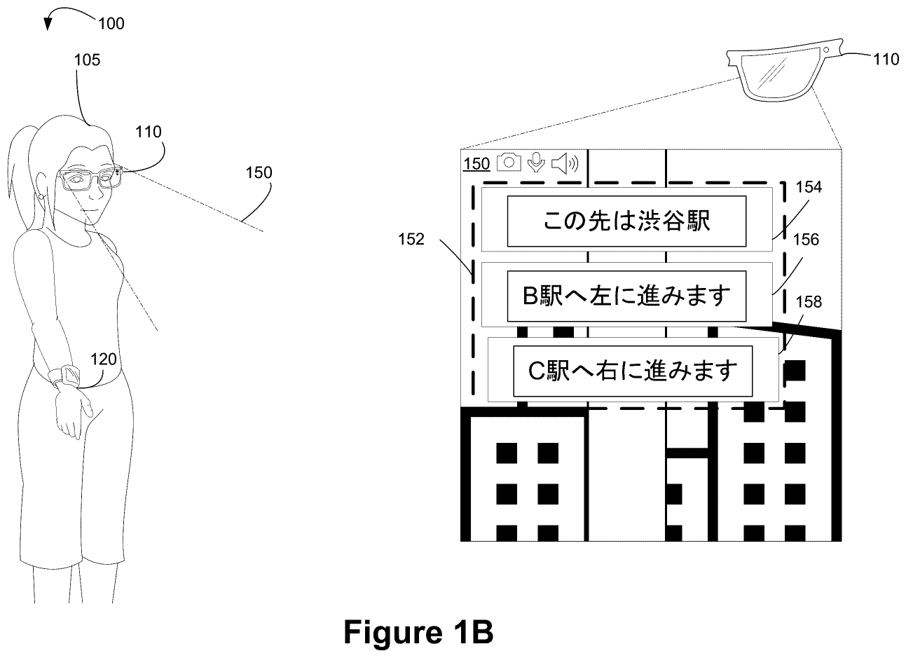

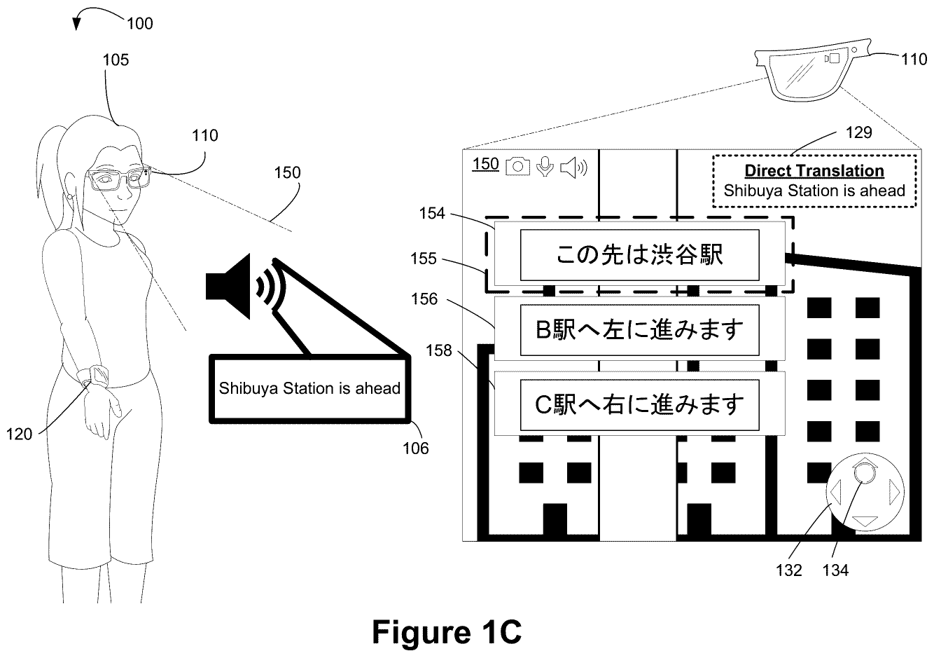

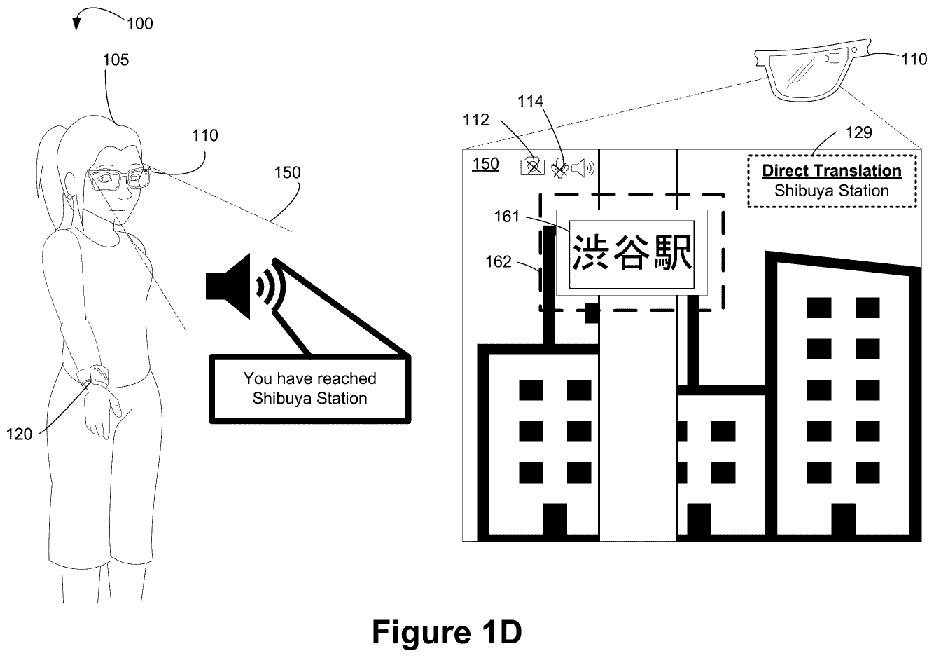

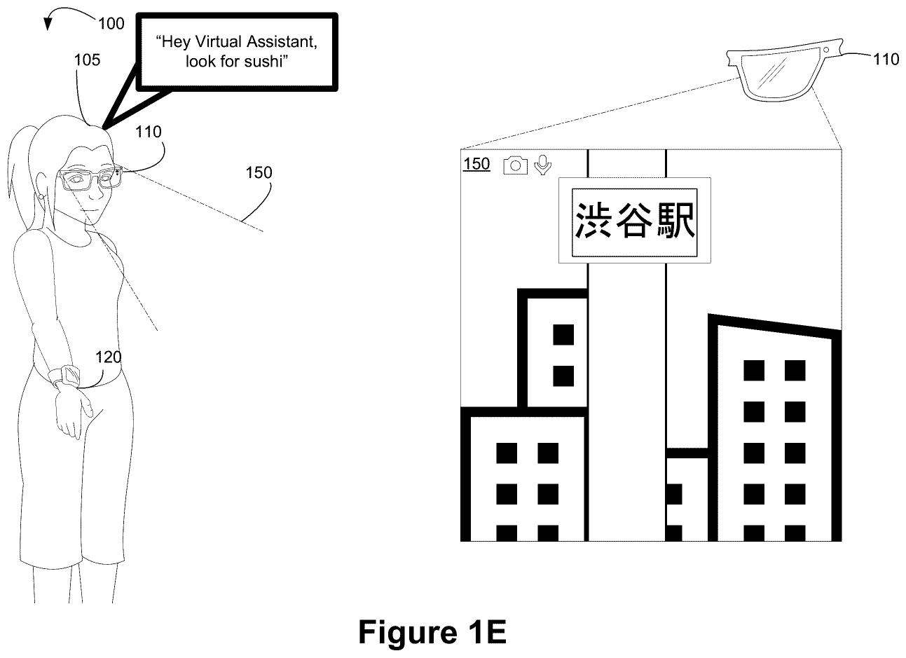

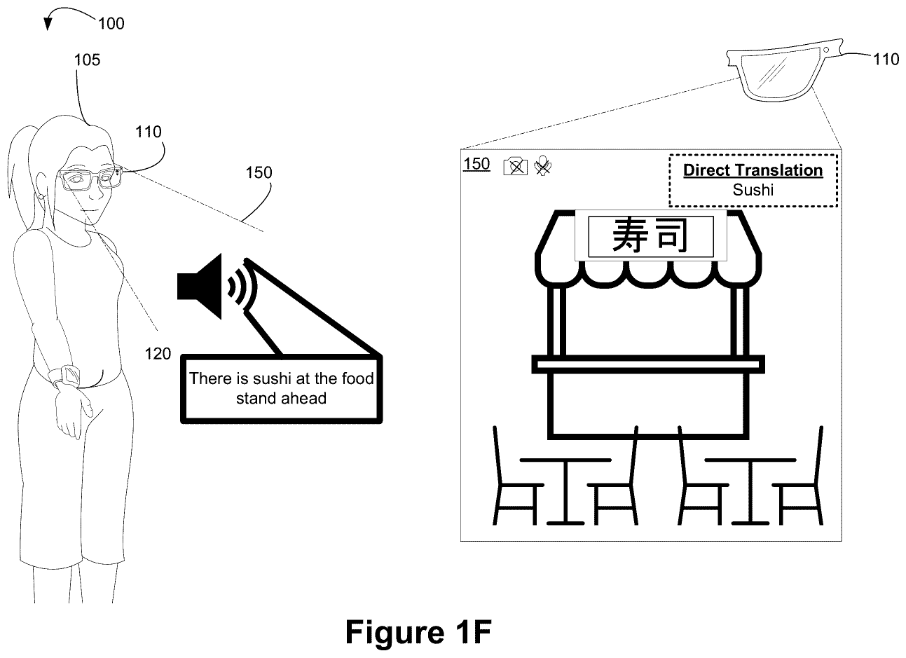

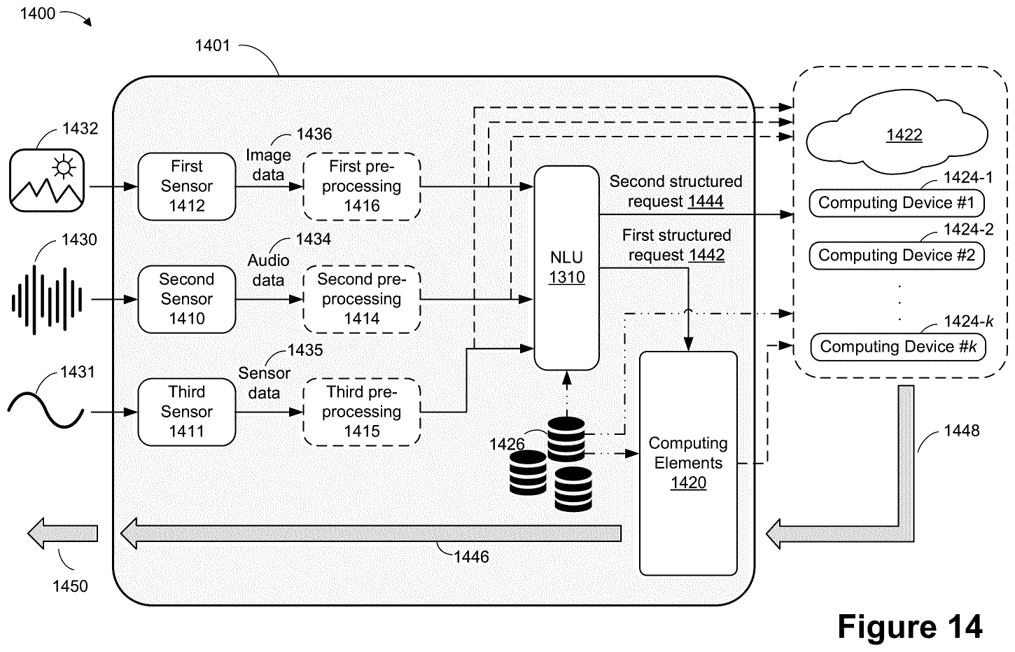

FIGS. 1A-1F illustrate a head-wearable device including an artificially intelligent assistant, in accordance with some embodiments. The AI assistant can be a conversational AI that is configured to understand, process, and respond to human language. The AI assistant can be customizable by the user to select languages, voices, personality, speech characteristics, etc. The AI assistant is included at a head-wearable device 110. The head-wearable device 110 can be part of any XR system described below in reference to FIGS. 16A-16C-2. An example system can include the head-wearable device 110 (e.g., AR device 1628 or MR device 1632), a wrist-wearable device 120 (e.g., wrist-wearable device 1626), a handheld intermediary processing device (HIPD) 1642, a mobile device 1650, and/or any other device described below in reference to FIGS. 16A-16C-2. A user 105 can wear and/or be carry one or more devices in an XR system. As shown and described below in reference to FIGS. 4 and 14, one or more models of the AI assistant can be included on-device (e.g., on a head-wearable device 110, wrist-wearable device 120, mobile device 1650, HIPD 1642, and/or other portable devices) and/or off-device or remotely (e.g., on a server 1630, a computer 1640, the HIPD 1642, and/or other devices with additional computational resources and/or larger power supplies).

On-device modules (including AI or machine-learning models) are used for processing operations that are not computationally intensive and allow for fast processing, whereas off-device modules (including AI or machine-learning models) are used for processing computationally intensive operations and provide higher accuracy outputs. Because on-device modules have low power consumption, can perform tasks with low latency, and require a minimal amount of computational resources, one or more on-device modules are included on wearable devices to reduce overall processing times. In some embodiments, on-device modules disclosed herein have a size less than or equal to 20 MB and a peak memory usage of less than or equal to 200 MB. In some embodiments, on-device modules disclosed herein have a size 8 MB or less. In some embodiments, on-device modules disclosed herein have a size 5 MB or less.

The user 105 can receive one or more alerts (e.g., alerts 102 and 122), haptic feedback 126, and/or other notifications via a device of the XR system. The different devices of the XR system can present visual and/or audio representations to the user 105. For example, the head-wearable device 110, the wrist-wearable device 120, a mobile device (not shown) can include one or more speakers and/or displays for presenting visual and/or audio representations to the user 105. Additionally, the different devices of the XR system can capture audio data, image data, sensor data, and/or any other device data (generally referred to as “contextual data”) to assist the user 105 in performing one or more operations. For example, the head-wearable device 110 can include an image sensor, a microphones, a GPS, bio-potential sensors, IMUs, eye-tracking sensors, thermometer, altimeters, and/or other sensors to capture data. Sensor data obtained by any sensors described herein can be used the XR system.

The user 105 can initiate the AI assistant via any one of the devices of the XR system. For example, the user 105 can initiate the AI assistant via one or more hand gestures, touch inputs (e.g., touch screen inputs, button inputs, touch inputs, etc. at a device), voice commands, and/or any other inputs detected by a device of the XR system. Alternatively, or in addition, in some embodiments, the user 105 can initiate the AI assistant via an application operating on the head-wearable device 110, the wrist-wearable device 120, and/or any other device of the XR system. For ease, one or more operations described below as described as benign performed by the AI assistant included in wearable device, such as head-wearable device 110.

In FIG. 1A, the user 105 wears the head-wearable device 110 and the wrist-wearable device 120. The user 105 is walking about and provides a request to an AI assistant-“Hey Virtual Assistant, look for Shibuya Station.” In some embodiments, the request initiates the AI assistant. More specifically, the request can include one or more query trigger cues (e.g., “Hey” or “Hey Virtual Assistant”) that, when detected by a device of the XR system, initiate the AI assistant. Alternatively, or in addition, in some embodiments, the user 105 can initiate the AI assistant using one or more devices of the XR system as described above. In some embodiments, the head-wearable device 110, the wrist-wearable device 120, and/or any other device of the XR system provide a notification that the AI system is active. For example, the head-wearable device 110, the wrist-wearable device 120 and/or any other device of the XR system can present via a display, a speaker, or other user-facing device a notification that the AI assistant is active.

In some embodiments, the head-wearable device 110 presents a user interface (UI) in response to the request to initiate the AI assistant. For example, the head-wearable device 104 presents, via a display, a one or more privacy UI elements, such as a microphone UI element 114 (indicating whether a microphone is active or inactive) and a camera UI element 112 (indicating whether an image sensor is active or inactive). Inactive devices are not shown or represented with a strikethrough (or an overlayed “X”). The head-wearable device 110, in response to initiating the AI assistant, captures contextual data as indicated by the camera UI element 112 and the microphone UI element 114. Similarly, the head-wearable device 110 can provide a notification of presented data. For example, a speaker UI element 116 is presented to show that the speaker is generating audible sound.

The head-wearable device 110 presents the UI over a portion of a field of view 150 of the user 105. The display of the head-wearable device 104 can be a monocular display (e.g., display on one display), a binocular display, and/or any other type of display (e.g., on a lens, each lens, projected on one or more lenses, etc.).

The AI assistant, in response to the request, utilizes contextual data captured by devices of the XR system to complete the request. For example, the AI assistant uses the contextual data captured by the head-wearable device 110 to locate and guide the user 105 to Shibuya Station. In particular, the AI assistant use the captured contextual data to recognize, at least, objects and/or text (e.g., using a scene-text recognition (STR) module 435, as described below in reference to FIG. 4).

In response to detecting the request, the head-wearable device 110 (or any other device of the XR system) captures contextual data at predetermined intervals (e.g., every 1 millisecond, 3 milliseconds, 1 second, 5 seconds, etc.). Alternatively, in some embodiments, the head-wearable device 110 (or any other device of the XR system) continuously captures contextual data in response to detecting the request. In this way, the head-wearable device 110 (or any other device of an XR system) is able to provide contextual data to the AI assistant without requiring the user 105 to manually capture image data. The head-wearable device 110 (or any other device of an XR system) ceases to capture contextual data in accordance with a determination that a response to the request has been provided (e.g., the request is complete), and/or a user input terminating operation of the AI assistant.

Turing to FIG. 1B, the user 105 navigates to a new location. At the new location, the user 105 is able to see street signs (e.g., a first street sign 154, a second street sign 156, and a third street sign 158) in their field of view 150. In order to provide a response to the request (e.g., locate Shibuya Station), the AI assistant can process the contextual data to detect one or more objects or regions of interest (ROI). The RIO can be presented to the user 105 via a bounding box overlaid over the ROI. For example, as shown in FIG. 1B, a first bounding box 152 is overlaid over the street signs. The ROI can be determined using the STR module 435 as discussed below in reference to FIG. 4.

The AI assistant further processes the ROI to identify text locations, words, word order, languages, and/or other cues for completing the request. The head-wearable device 110 and/or the AI assistant can use the ROI to translate text (without requiring the use of a separate translation application), summarize text, annotate one or more portions of text, tag one or more portions of text, define one or more words, and/or perform other operations described herein. The different operations on the ROI can be performed on one or more on-device and/or off-device components and/or modules described herein.

FIG. 1C shows the AI assistant selecting a portion of the ROI. The AI assistant can detect one or more portions of the ROI that are relevant to completing the request. For example, the AI assistant can detect each of the first street sign 154, second street sign 156, and the third street sign 158; detect text within each of the respective signs; and identify the signs relevant for completing the request. The portions of the ROI relevant to completing the request are presented to the user 105 via a visual indicator and and/or audible indicator. For example, as shown in FIG. 1C, a second bounding box 155 is overlaid the first street sign 154 to indicate that the sign is relevant to the response. Alternatively, or in addition, in some embodiments, the user 105 can provide one or more inputs to navigate through different portions of the ROI. For example, as indicated by a controller UI element 132, the user 105 provides an input (e.g., hand gesture, touch inputs, etc.) to scroll upwards (represented by AR thumbstick 134) and select the first street sign 154.

The AI assistant can analyze text and/or objects within the one or more portions of the ROI to provide a response. The AI assistant can detect different languages within the one or more portions of the ROI and translate the languages for the user 105. For example, in FIGS. 1C, the AI assistant detects that the first street sign 154 is in Japanese and translates the first street sign 154 for the user 105. The translation can be presented to the user 105 via the head-wearable device 110 and/or another device. For example, in FIG. 1C, a translation overlay UI element 129 is presented via the head-wearable device. In some embodiments, the translation overlay UI element 129 is disposed over the translated object and/or text (e.g., over the first street sign 154). Alternatively, or in addition, in some embodiments, the head-wearable device 110 presents an audio representation of the translation.

Because the user 105 has not reached Shibuya Station, the AI assistant remains active and continues to guide the user 105 to Shibuya Station.

FIG. 1D shows the user 105 reaching the Shibuya Station. The AI assistant uses captured contextual data to detect a station sign 161 for Shibuya Station. As described above, the detected station sign 161, ROI, and translation are presented to the user 105.

Because the user 105 has reached Shibuya Station, the AI assistant is deactivated and the one or more devices of the XR system cease to capture contextual data (as indicated by the crossed-out microphone UI element 114 and the crossed-out camera UI element 112).

FIGS. 1E and 1F show the user 105 re-initiating the AI assistant to search for food (e.g., sushi). The AI assistant can utilize location data (e.g., GPS data, application data, map data, etc.) to identify and direct the user 105 to a food stand or restaurant. While directing the user 105 to the food stand or restaurant, the AI assistant remains active and the one or more devices of the XR system capture contextual data. This allows the AI assistant to detect and identify the food stand or restaurant for the user 105. For example, as shown in FIG. 1F, when the sushi restaurant is detected, the AI assistant presents a visual and/or audio notification identifying the sushi restaurant for the user 105. When the user 105 arrives to the sushi restaurant, the AI assistant is deactivated and the one or more devices of the XR system cease to capture contextual data.

The head-wearable device 110 (and the included AI assistant) assist users in overcoming language barriers when traveling or interacting with foreign languages by providing an easy and convenient way to translate text in real-time. While the examples of FIGS. 1A-1F show the AI assistant implemented in an AR device 1628 (e.g., the head-wearable device 110), the AI assistant can be used in MR devices 1632 and used in MR environments (e.g., interacting with different virtual environments that may include foreign languages or virtual landmarks).

### Adaptable AI Assistant Responses

FIGS. 2A-2C illustrate adaptable responses provided by the artificially intelligent assistant, in accordance with some embodiments. As described above in reference to FIGS. 1A-1F, the AI assistant in included in the head-wearable device 110 and/or any other device of an XR system. In FIG. 2A, the user 105 provides a request to find brand B coffee. The AI assistant, in response to the request, is initiated and the head-wearable device 110 (and/or other devices of the XR system) capture contextual data that is used by the AI assistant to provide a response to the request. The AI assistant can identify one or more locations and/or options for satisfying the request. The AI assistant can provide one or more options for responding to the request, as discussed below.

In FIG. 2B, the user 105 navigates to a new location. At the new location, the user 105 is able to see a store and street signs (e.g., a fourth street sign 230 and a fifth street sign 240) in their field of view 150. Contextual data captured by the head-wearable device 110 is processed by the AI assistant to detect one or more objects or ROIs. image data. For example, the AI assistant identifies a store sign 210, a coffee poster 220, the fourth street sign 230, and the fifth street sign 240. A bounding box is presented to assist the user 105 in identifying relevant objects and/or ROIs. For example, the head-wearable device 110 presents a second bounding box 215 overlaid over the store sign 210, a third bounding box 225 overlaid over the coffee poster 220, and a fourth bounding box 245 overlaid over the fourth street sign 230, and the fifth street sign 240.

Turning to FIG. 2C, the AI assistant analyzes the detected ROIs and notifies the user 105 of different options for completing the request. For example, the AI assistant notifies the user 105, via the head-wearable device 110, that coffee can be found within the store and that a brand B coffee store can be found to the right. In this way, the AI assistant provides the user 105 with different options for completing the request and allows the user 105 the opportunity to select their preferred response. In some embodiments, the AI assistant automatically selects a response; however, makes other options available such that the user 105 can switch to another option (if the automatically selected option is not the preferred option).

### Example AI Assistant Interactions

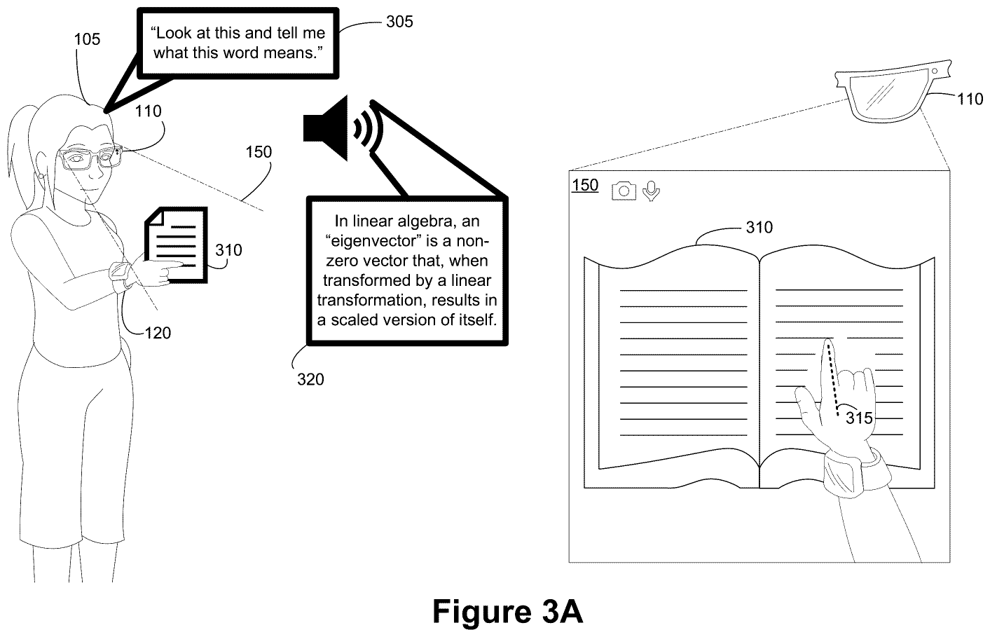

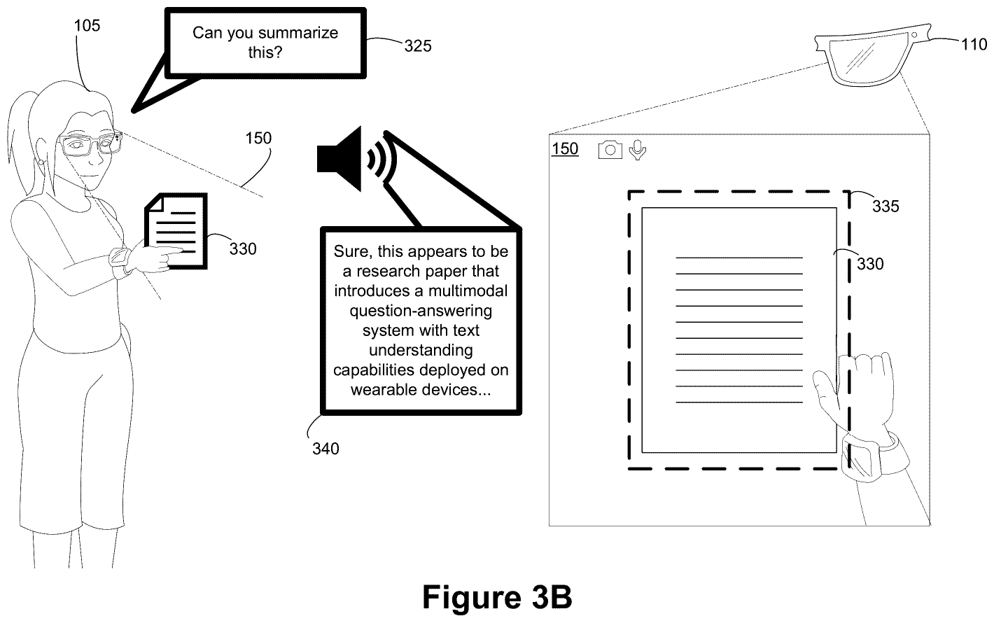

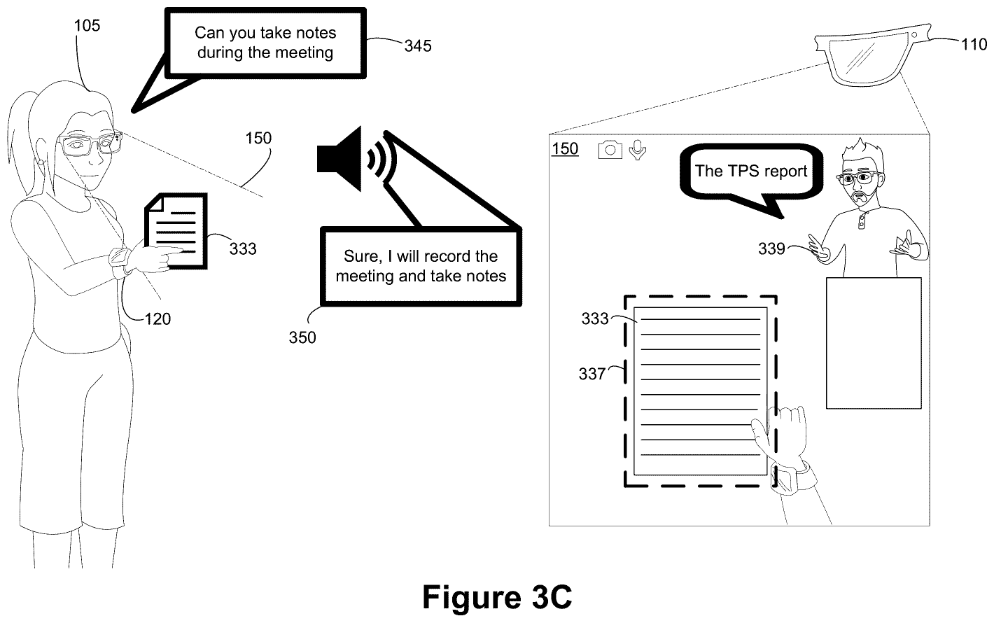

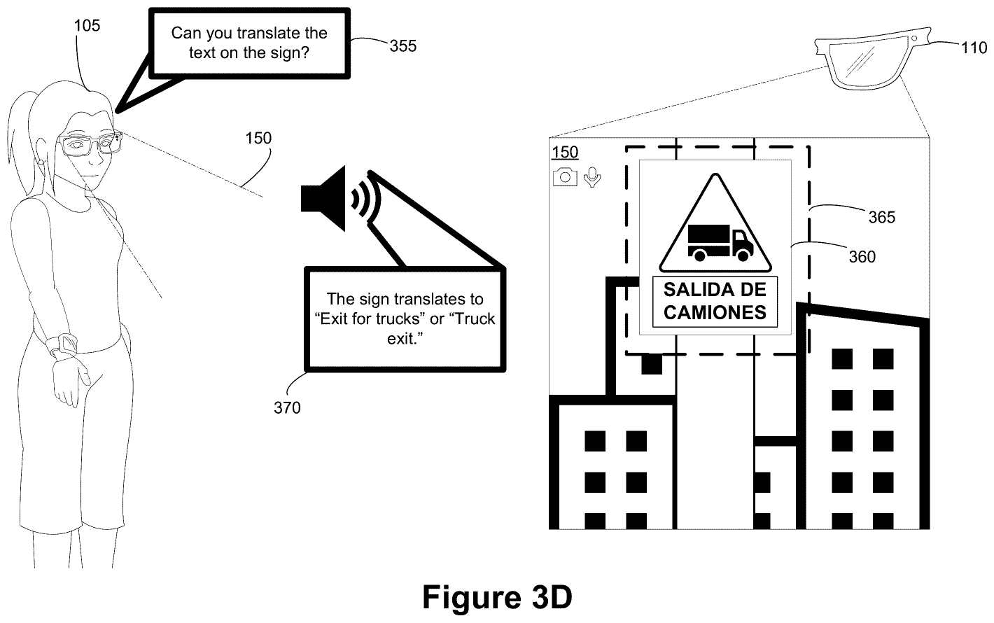

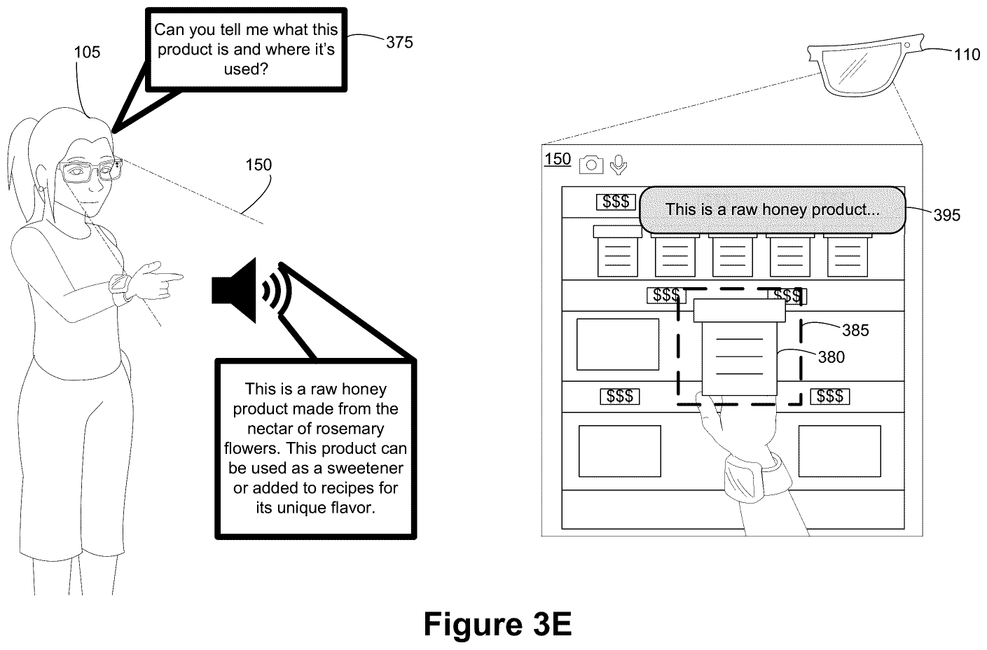

FIGS. 3A-3E illustrates example interactions using an AI assistant included in a head-wearable device, in accordance with some embodiments. The AI assistant can operate as a productivity tool and/or organization tool to assist the user 105 in everyday tasks. In particular, the AI assistant can assist the user 105 in analyzing, organizing, recording, summarizing, and/or transcribing conversations, information, and/or documents (handwritten and/or typed documents). The AI assistant is configured to enhancing learning by making it easier for a user 105 to use the processed data when creating action items and/or collaborating with others. In this way, the AI assistant operates as a time-saving tool that reduces the number of manual inputs required by the user 105. The head-wearable device 110 and the AI assistant can perform one or more operations and/or use one or more modules in assisting the user 105, such as handwriting recognition (e.g., using a STR module 435), gesture recognition (e.g., detected via image data, biopotential-signal sensor data (e.g., EMG data), IMU data, etc.), audio speech recognition (e.g., using an audio speech recognition (ASR) module 440), and large language models (LLMs). The AI assistant can utilize one or more components of devices within an XR system (e.g., any XR system described below in reference to FIG. 16A-16C-2).

Turning to FIG. 3A, the user 105 wearing a head-wearable device 110 initiates the AI assistant and requests additional information for an object (e.g., document 310). The AI assistant detects the object based on one or more of contextual data captured by the head-wearable device 110 (or other device of the XR system). For example, the AI assistant is initiated in response to a first verbal query 305—“Look at this and tell me what this word means?” The AI assistant, when initiated, uses contextual data to determine contextual cues associated with the request in order to provide a response to the request. For example, the AI assistant uses, at least, the first verbal query 305 and image data of a field of view 150 of the user 105 to determine that the document 310 is an object of interest; and the image data of the field of view 150, the first verbal query 305, and the sensor data (e.g., inferring finger point 315, hand motion, body motion, eye-tracking data, etc.) to identify the word referenced by the user 105.

As described below in reference to FIG. 4, the head-wearable device 110 (or other device of the XR system), the contextual data can be cropped, resized, formatted, and/or modified to provide a response to the user request. For example, the first verbal query 305 can be analyzed to i) infer that the head-wearable device 110 imaging device should be initiated to capture the image data of the field of view of the user 105; ii) determine that the document 310 should be cropped from the image data of the field of view of the user 105 the first verbal query 305; and iii) search for the word referenced by the user 105. In other words, the AI assistant can identify the document 310 as an ROI, cause the ROI to be cropped for further processing, and use the finger point 315 to identify a portion of the ROI related to the request. As described below, the cropped image data can be used to detect text, text locations, recognize text, determine text order, recognize paragraphs, and/or determine paragraph order.

The AI assistant, in response to the request, generates a response and provides the response to the user 105. The response to the request (e.g., the first verbal query 305) can include a textual response and/or an audio response. For example, as shown in FIG. 3A, the AI assistant provides a first response 320 as audio feedback to the request (e.g., “In linear algebra an ‘eigenvector’ is . . . ”).

In some embodiments, the AI assistant can detect one or more wearable devices worn by the user 105 and/or other devices associated with the user 104 that are available for communicating with the head-wearable device 110. In response to detecting at least one wearable device worn by the user 105 and/or at least device associated with the user 104 that is available for communicating with the head-wearable device 110, the AI assistant request for additional contextual data and/or additional contextual cues from the at least one wearable device worn by the user 105 and/or at least device associated with the user 104. For example, the AI assistant can detect the user 105 is wearing a wrist-wearable device 120 and request from the wrist-wearable device 120 additional contextual data and/or additional contextual clues including a position of a hand of a user, an intended hand movement of the user 105 (e.g., using biopotential or captured EMG signals), surface contact gestures (e.g., tapping on a portion of the document 310), etc. The AI assistant can use the contextual data and the additional contextual data to generate a response (e.g., the firs response 320) to the user query (e.g., first verbal query 305). In some embodiments, the AI assistant can use other contextual data and/or other contextual cues to generate the response to the user query. For example, the user 104 can be in possession of an HIPD 1642 (FIG. 16) that stores a schedule (e.g., a class schedule) of the user 105 and/or is recording a lecture of a class the user 105 is attending, and the AI assistant can request the class schedule and/or a portion of the lecture recording to generate the response to the user query (e.g., the user 105 is in a linear algebra class and a response related to linear algebra is requested).

In FIG. 3B, the user 105 provides a second verbal request 325. The second verbal request 325 asks for a summary of a held document 330. In response to the second verbal request 325, the AI assistant is initiated, and contextual data is captured to prepare a response to the second verbal request 325. The AI assistant uses the second verbal request 325 and the contextual data to identify the held document 330 as the object of interest (represented by first outline 335) and an action to be performed on the held document 330. The AI assistant processes the contextual data and contextual cues related to the held document 330 and summarizes the held document 330. The AI assistant, in response to the second verbal request 325, provides a second response 325 summarizing the held document 330.

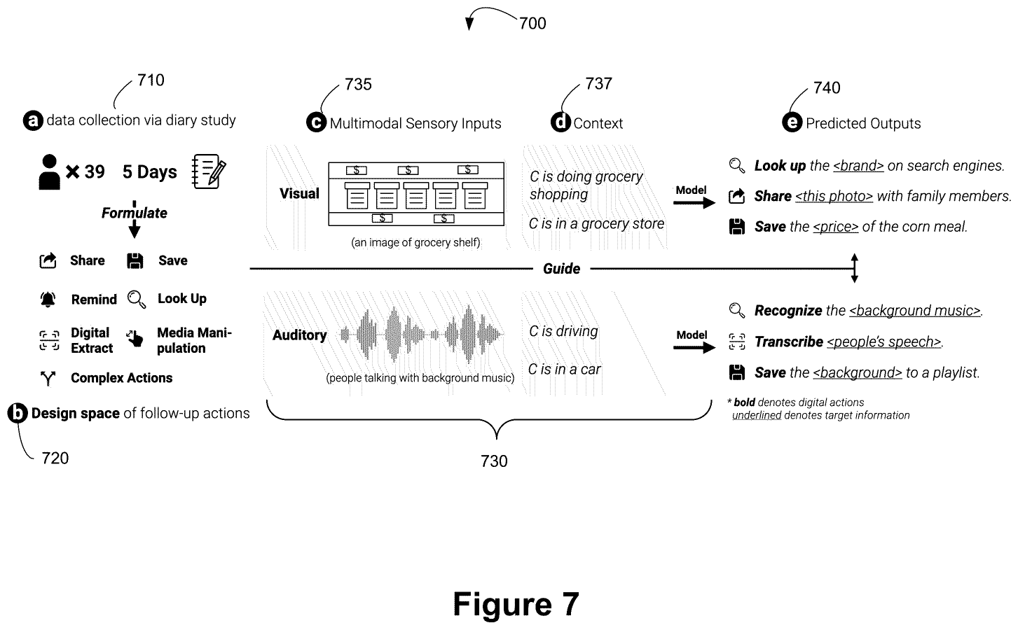

In some embodiments, as described in reference to FIGS. 7-11, the AI assistant can generate and present one or more follow-up actions to the user. For example, the AI assistant can ask the user 105 if they would like to store the summary, store a copy of image data including the document 330, search for the document 330, search for portions of the document 330 (e.g., citations, authors, words, related research, positive citations to the document 330, negative citations to the document, etc.), share the document 330, share the summary 330, and/or any other follow-up action generated by the AI assistant.

In FIG. 3C, the user 105 provides a third verbal request 345. The third verbal request 345 asks for assistance note taking. In response to the third verbal request 345, the AI assistant is initiated, and contextual data is captured to prepare a response to the third verbal request 345. The AI assistant uses the third verbal request 345 and the contextual data to identify the meeting notes 333 as the object of interest (represented by outline 337), associate a presentation (speech, presented content, and/or other information shared with the user 105) of a speaker 339 to the meeting notes 333, and actions to be performed on the meeting notes 333 and the presentation of the speaker 339. The AI assistant, in response to the third verbal request 345, provides a third response 350 confirming that the AI assistant is supplementing a meeting.

Actions to be performed by the AI assistant can include, without limitation, transcribing captured audio data, tagging portions of captured image data, annotating notes or documents (e.g., meeting notes 333), storing the captured image data; audio data; completed actions; generated responses; and/or inferences from the contextual data and/or contextual cue, sharing data, forming study groups, scheduling study sessions, capturing actions items, etc. For example, the AI assistant can process contextual data and contextual cues related to the meeting notes 333 and the presentation of the speaker 339 to create a recording of the presentation (e.g., capture of image and/or audio data), associate portions of the presentation with the meeting notes 333, create one or more tags within the recording, create action items to be performed by the user 105 and/or meeting participants, create reminders, and/or other productivity and/or organization related actions. In some embodiments, the contextual data can include eye-tracking data and the AI assistant can use the eye-tracking data to detect one or more objects of interests in the presentation and tag and/or summarize the objects of interest for the user 105.

As described above, the AI assistant can request data from one or more devices associated with the user 105. The AI assistant can use the addition data from the one or more devices associated with the user 105 to perform the actions associated with the request. For example, the AI assistant can use sensor data captured by a wrist-wearable device 120 to detect hand gestures performed by the user 105 to pause and/or continue a recording, modify a recording, confirm or reject AI queries or suggestions (e.g., pinch gesture to agree with annotation), adjust volume settings, etc. In some embodiments, the data from the wrist-wearable device 120 can be used in conjunction with the contextual data captured by the head-wearable device 110 to interpret user hand positions, pointing, etc. In some embodiments, the data from the wrist-wearable device 120 can be used in conjunction with the contextual data to detect and capture user handwriting (e.g., on paper, on a surface (e.g., using their figure or object).

In this way, when the user 105 is in a meeting, a lecture, or other content sharing event, the user 105 is free to take notes (e.g., take handwritten or typed notes, draw on a white board, etc.), talk, and listen to others, while the AI assistant makes annotations and tags in the notes. The AI assistant will further process, interpret, and record the contextual data so that users can store, playback, and query the contextual data. The AI assistant allows users to revisit the past meetings as contents of the meeting are automatically digitalized so that users can focus on sections that where tagged (by the AI assistant or the users) as interesting or challenging. The AI assistant also allow the user to collaborate with others by allowing the user to identify participants and/or share content with others.

FIG. 3D provides an example of a fourth verbal request 355. The fourth verbal request 355 asks for a translation of information. In response to the fourth verbal request 355, the AI assistant is initiated, and contextual data is captured to prepare a response to the fourth verbal request 355. The AI assistant uses the fourth verbal request 355 and the contextual data to identify a sign 360 as the object of interest (represented by third outline 365) and an action to be performed on the sign 360. The AI assistant processes the contextual data and contextual cues related to the sign 360 and translates the sign 360. The AI assistant, in response to the fourth verbal request 355, provides a fourth response 370 presenting a translation of the sign 360.

In some embodiments, to reduce the overall latency in generating a response, the AI assistant can use additional contextual data to reduce processing. For example, the AI assistant can utilize location data captured by the head-wearable device 110 and/or any other communicatively coupled device to identify a location of the user 105 and utilize the location information to reduce total processing. In FIG. 3D, the AI assistant can use user location information to determine that the user is in a Spanish speaking country and reduce overall latency in generating a response by preconfiguring translations from Spanish (e.g., instead of having to identify a language through inferences).

FIG. 3E provides an example of a fifth verbal request 375. The fifth verbal request 375 asks for identification of a held product 380. In response to the fifth verbal request 375, the AI assistant is initiated, and contextual data is captured to prepare a response to the fifth verbal request 355. The AI assistant uses the fifth verbal request 355 and the contextual data to identify the held product 380 as the object of interest (represented by fifth outline 385) and an action to be performed on the held product 380. The AI assistant processes the contextual data and contextual cues related to the held product 380 and identifies the held product 380, provides a description of the held product 380, performs a search of the held product 380, compares prices of the held product 380, and/or performs other operations related to the held product 380. The AI assistant, in response to the fifth verbal request 375, provides a fifth response 390 presenting a description of the held product 380. Alternatively, or in addition, the AI assistant can present a visual response 395 in response to a user query (e.g., fifth verbal request 375). For example, a display of the head-wearable device 110 can present a user interface including a portion of the fifth verbal request 375 and/or other responses related to the user query. In some embodiments, the user can provide a user input selectin the visual response 395 for performing additional options (e.g., expanding visual response 395 to show all, show follow-up action associated with the visual response 395, show other purchasing options, etc.).

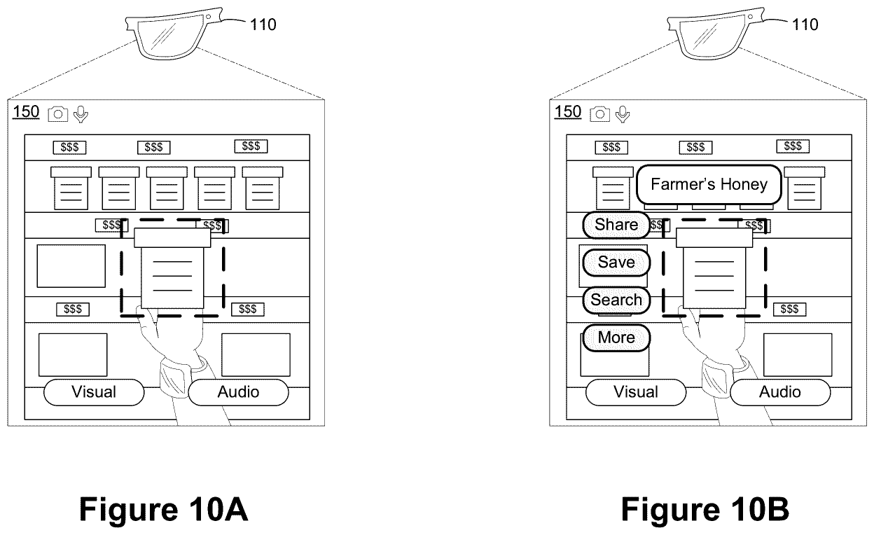

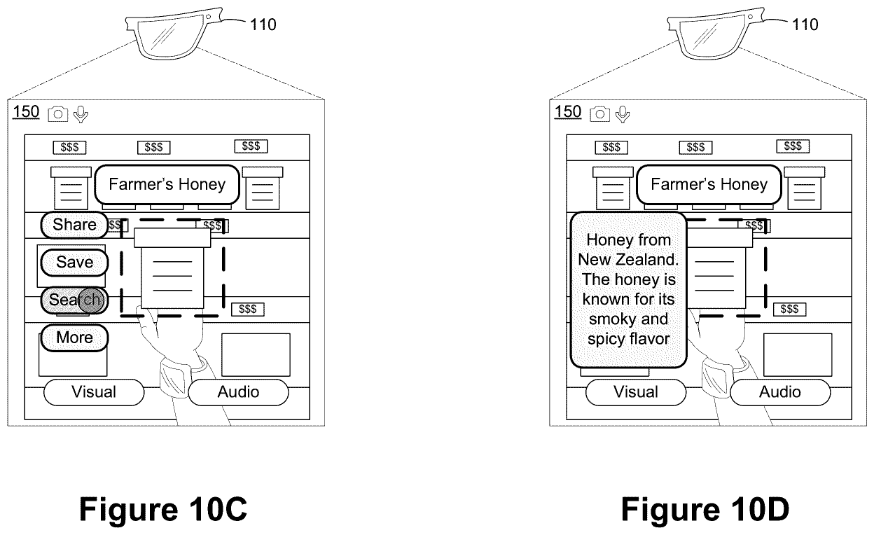

In some embodiments, the AI assistant can locate other stores near the user 105 with the same or similar product and provide the use 105 with different prices and/or other purchase options. In some embodiments, the AI assistant can utilize the object of interest 385 to generate a grocery list or check off items from a grocery list. In some embodiments, the AI assistant can present one or more reviews associated with the object of interest 385. As discussed below in reference to FIGS. 10A-10D different follow-up actions can be presented to the user 105.

While FIGS. 3A-3E illustrate the AI assistant initiated via a verbal query, in some embodiments, the AI assistant is generated via one or more hand gestures (detected by the head-wearable device 110, wrist-wearable device 120, and/or other device), touch inputs at head-wearable device 110, wrist-wearable device 120, and/or other device. In some embodiments, the AI assistant can be initiated through a gaze of the user 105, user blinks, and/or other inputs.

### Example AI Assistant System at a Wearable Device

FIG. 4 illustrates an example AI assistant system for providing a responses to a user request via a wearable device, in accordance with some embodiments. The AI assistant system 400 shows one or more components and/or modules for of an AI assistant included at a wearable device, such as a head-wearable device 110 (FIGS. 1A-3E), and/or a communicatively coupled device (e.g., a server 1630, a computer 1640, an HIPD 1642, etc.; FIGS. 16A-16C-2). For example, the AI assistant system 400 show on-device components 420 included at a head-wearable device 110 and server-side components 450 included at a server 1630. While the AI assistant system 400 shows on-device components and server-side components, in some embodiments, the components of the AI assistant system 400 are on a single device.

The width of the boxes and the weights of the arrows shown in the AI assistant system 400 are representative of processing and transfer times. For example, as represented in FIG. 4, an STR module 435 utilizes a majority of the image processing time, whereas a compression and transfer module 430 utilizes a majority of the transfer time (e.g., transfer of low-resolution image data). To reduce latency, in some embodiments, only low-resolution image data is transferred to server-side components. The AI assistant system 400 uses hardware accelerators and/or hardware acceleration techniques implemented on wearable devices and/or edge devices (e.g., image sensors, microphones, sensors, etc. included and/or communicatively coupled with a wearable device) to perform one or more operations. For example, hardware accelerators of a head-wearable device 110 can be used to perform operations of an ASR module 440, STR module 435, and/or other on-device components 420.

As described above in reference to FIGS. 1A-3E, the AI assistant is initiated in response to detection of a query trigger. In particular, the AI assistant is initiated in response to a detected query trigger. When the AI assistant is initiated, the head-wearable device 110 captures contextual data via one or more edge devices. For example, the head-wearable device 110 can activate, at least, a first edge device 405 to capture image data and a second edge device 410 to capture audio data. The head-wearable device 110 can include and/or be communicatively coupled with any number of edge devices. Similarly, the AI assistant system 400 can receive contextual data from any number of communicatively coupled edge devices.

The AI assistant system 400 processes a portion of the contextual data at the head-wearable device 110. Processes performed on the portion of the contextual data can be performed in parallel or sequence. As shown by the AI assistant system 400, the audio data of the contextual data is processed at the head-wearable device 110 using an ASR module 440. The ASR module 440 can be used to detect a query trigger and/or be used after a query trigger is detected (e.g., a hand gesture, device input, and/or voice input (e.g., a wake-word or predetermined query trigger phrase) is detected). The ASR module 440 is used to detect contextual cues in audio data. For example, the ASR module 440 can be used to identify keywords, object of interest, words of interest, action items, and/or other contextual cues related to a request. The audio contextual cues are identified as a user query.

Image data of the contextual data (e.g., photo capture 425) provided to the AI assistant system 400 is processed by the compression and transfer module 430 and the STR module 435. The compression and transfer module 430 compresses image data of the contextual data from a first resolution (e.g., full-resolution image data (e.g., 3k×4k)) to a second resolution (e.g., a thumbnail image (e.g., a 432×576 thumbnail image)). The compression and transfer module 430 transfers compressed image data of the contextual data to the server-side components 450. For example, the compression and transfer module 430 compresses the photo capture 425 and transfers the compressed photo capture 425 to the server-side components 450. The compressed image data of the contextual data (e.g., a thumbnail image) is transferred to the server-side components 450 in parallel with an output of the ASR module 440 (e.g., the processed audio data of the contextual data) to reduce overall system latency.

The operations of the STR module 435 are performed in parallel with the operations of the compression and transfer module 430 and the ASR module 440. Additionally, in some embodiments, the compression and transfer module 430 and the ASR module 440 transmit their respective outputs to the server-side components 450 while operations of the STR module 435 are performed. The operations of the STR module 435 are initiated when the image data of the contextual data is available. The STR module 435 uses image data having the first resolution (e.g., full-resolution image data) and operates in parallel to the compression and transfer module 430. In some embodiments, the STR module 435 uses image data having the second resolution (e.g., a thumbnail image) to perform one or more operations. In some embodiments, the STR module 435 receives the image data having the second resolution from the compression and transfer module 430 or compressed the image data having the first resolution.

As an overview, the STR module 435 uses image data having the first resolution and/or image data having the second resolution to detect and identify ROIs. The STR module 435 can further process the full-resolution image data to crop the ROIs and remove surrounding or background image data (e.g., image data that does not include the ROI). The STR module 435 identifies at least recognized text and text locations that are provided to the server-side components 450 in conjunction with the outputs of the ASR module 440 and the compression and transfer module 430. The STR module 435 uses a portion full resolution image (e.g., the ROI of the full resolution image) to improve quality and accuracy. To reduce latency, hardware acceleration and/or hardware accelerators of the head-wearable device 110 are used to perform operations of the STR module 435, as well as the transfer image data in parallel. Outputs of the STR module 435 are provided to a multi-modal LLM (MM-LLM 460) to improve the MM-LLM 460 use cases. The MM-LLM 460 is configured to selectively use outputs of the compression and transfer module 430, STR module 435, and the ASR module 440 based on the request-an approach that is feasible due to the reduction of latency (particularly through parallelization) and optimization of hardware efficiency for the STR module 435. The STR module 435 is configured to have a small memory and compute footprint, and is configured for efficient battery usage with minimum impact on quality. For example, the STR module 435 can have a total size less than or equal to 20 MB, a peak memory usage of less than or equal to 200 MB, and an average latency of less than or equal to 1 second. Specific detail of the STR module 435 and its operations is provided below.

The STR module 435 includes one or more sub-components. In some embodiments, the sub-components of the STR module 435 include an ROI detection module, a text detection module, a text recognition module, and a reading order reconstruction module. The ROI detection module takes an egocentric image (e.g., a first point-of-view image) as input (at both 3k×4k resolution and a thumbnail resolution) and outputs a cropped image (about 1k×1.3k resolution) that contains all the text needed to answer the user request. The ROI detection module ensures that the remaining sub-components of the STR module 435 use a portion of the captured image data relevant to the request, which reduces both computational cost and background noise. The text detection module takes a cropped image from ROI detection module as input (e.g., a portion of the full-resolution image that is relevant to the user query), detects one or more words, and outputs the identified bounding box coordinates for each word. The text recognition module takes the cropped image from ROI detection module and the word bounding box coordinates (from the text detection module) as input, returns the recognized words. The reading order reconstruction module organizes recognized words into paragraphs and in reading order within each paragraph based on the layout. The reading order reconstruction module outputs text paragraphs as well as their location coordinates.

The ROI detection module removes non-essential information from a full-resolution image such that a portion of the image data including the text area of interest is processed, which reduces the use of computational power and battery power of the device. The ROI detection module identifies background text that is irrelevant to a request (e.g., text that is not relevant to the request, such as text surrounding the word pointed at by the user in FIG. 3A, and/or text from the background products shown in FIG. 3E), and removes that background text to conserve hardware resources, decrease the latency, and improve the MM-LLM 460 performance. The ROI detection module uses a low-resolution thumbnail 432×576 to detect the ROI, and returns the cropped area from the raw image 3k×4k containing the ROI.

To identify an ROI, the ROI detection module identifies one or more objects within the image data. For example, for a finger pointing gesture identifying a word, the ROI detection module detect at least two points—the last joint and the tip of index finger, which formulate a pointing vector. In some embodiments, the ROI detection module is trained to detect different events, such as pointing events, trigger words, keyword detection, etc., and provides the recognized event to the MM-LLM 460 (e.g., the event is provided as an additional prompt to the MM-LLM 460). For example, a prompt to the MM-LLM 460 can include a description of a pointing event as well as the words and the paragraphs closest to the tip of the index finger in the direction of the pointing vector.

The text detection module uses cropped image (which, in some embodiments, is a cropped portion of the in full-resolution image data) from the ROI detection module as input, and predicts location of each word as bounding boxes. The text detection module is trained to account for the tilted text, text of different sizes, etc.

The text recognition module uses the cropped image from the ROI detection module and the word bounding box coordinates from the text detection module as an input, and outputs recognized words for each bounding box. The text recognition module can detect different text appearances in terms of fonts, backgrounds, orientation, and size, as well as variances in bounding box widths. In some embodiments, during training of the text recognition module, to handle the extreme variations in bounding box lengths, curriculum learning is performed (e.g., input image complexity is gradually increased).

The reading order reconstruction module is configured to connect the words to paragraphs from the text recognition module and return the words in the paragraph in reading order, together with the coordinates of each paragraph. The reading order reconstruction module connects the words to paragraphs and expands the word bounding boxes both vertically and horizontally by predefined ratios. The expansion ratios are selected to fill the gaps between words within a line and lines within a paragraph. In some embodiments, the expansion ratios are the same for all bounding boxes. The reading order reconstruction module groups bounding boxes that have significant overlap after expansion as a paragraph. For each paragraph, the reading order reconstruction module applies a raster scan (sort by Y coordinate then X) to the words to generate the words in reading order. The reading order reconstruction module computes the location of the paragraph by finding the minimum area rectangle enclosing all words in the paragraph.

Turning to the server-side components 450, the server receives one or more of an output of the compression and transfer module 430 (e.g., compressed image data or a thumbnail image)), an output of the STR module 435 (e.g., recognized text, text locations, text coordinates, etc.), and an output of the ASR module 440 (e.g., a user query based on processed audio data). The MM-LLM 460 receives, as input, the low-resolution thumbnail and a prompt generated by a prompt designer module 455, and generates a response to the request. The prompt designer module 455 uses one or more of the output of the STR module 435 and the output of the ASR module 440 to generate the prompt (a structure request based on a plurality of data sets). The response generated by the MM-LLM 460 is provided to the wearable device for presentation to a user. One or more models can be used in place of, or in addition to the MM-LLM 460. Additional models contemplated are described below in reference to FIG. 16A. In some embodiments, a text-to-speech (TTS) module 465 is used to convert the generated response to an audible response 470 presented to the user via a speaker or other device. Alternatively, or in addition, in some embodiments, the generated response is presented to the user via a display, haptic feedback or other means.

As described above, due to latency constraints, low-resolution image data (e.g., a thumbnail image) is provided to the MM-LLM 460. To ensure accuracy and quality in the results, the STR module 435 is used to enhance text understanding capability. The MM-LLM 460 can be configured to operate with different inputs. For example, the MM-LLM 460 can use at least three different input variations—i) the thumbnail and user query; ii) the thumbnail, user query, and STR text; and iii) the STR module 435 outputs including positions (e.g., paragraph locations as determined from reading order reconstruction module) in addition to the inputs for ii). Adding positions (e.g., paragraph locations) to the STR module 435 further improves the performance on all tasks, with the largest improvement being on the word lookup task (+56.2% with positions vs +51.1% without).

In some embodiments, additional contextual data and/or additional contextual clues obtained by at least one wearable device worn by the user 105 and/or at least device associated with the user 104 that is available for communicating with the head-wearable device 110 is provided in conjunction with the contextual data such that all the data is processed together. Alternatively, or in addition, in some embodiments, the additional contextual data and/or the additional contextual clues are provided in parallel. In some embodiments, the additional contextual data and/or the additional contextual clues are provided after the contextual data and/or contextual clues (e.g., in sequential order). In some embodiments, the additional contextual data and/or the additional contextual clues are used to increase accuracy, reduce latency, and/or generate more detailed responses.

### Outputs of the Scene-Text Recognition Module

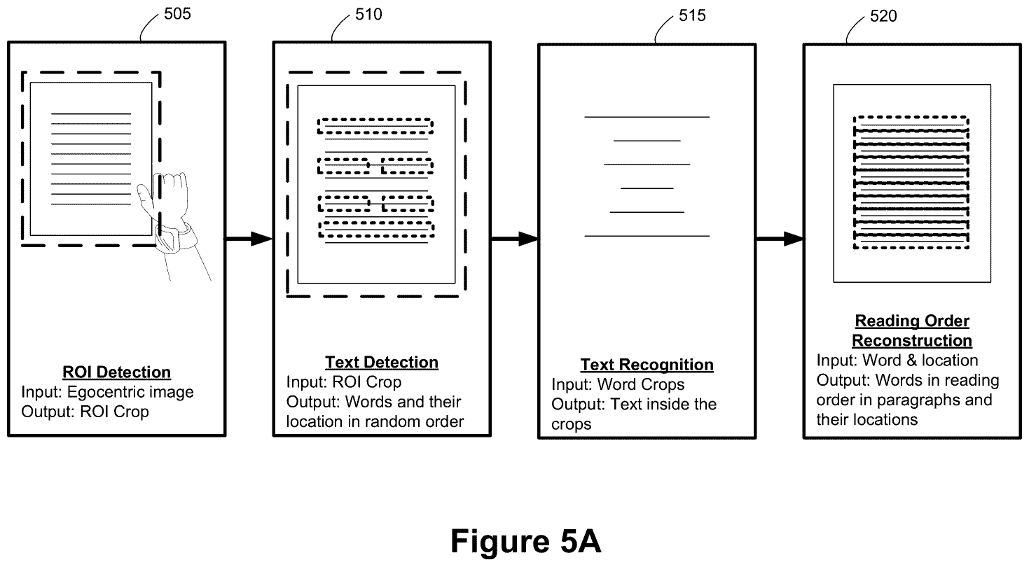

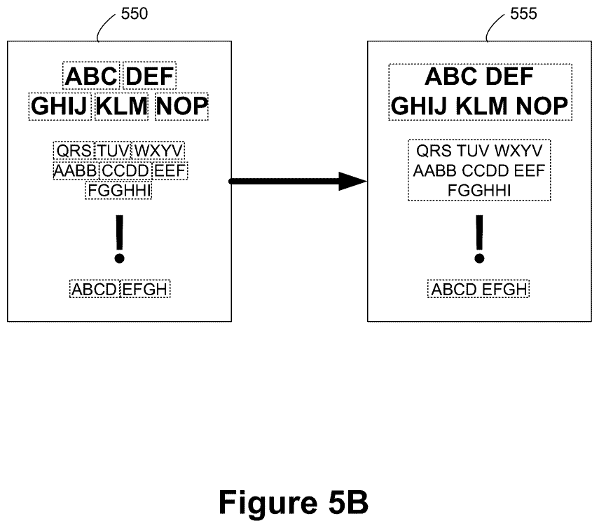

FIGS. 5A and 5B illustrate outputs of the scene-text recognition module, in accordance with some embodiments. In particular, FIG. 5A illustrates an output ROI 505 of the ROI detection module, a detected text output 510 of the text detection module, a recognized text output 515 of the text recognition module, and a reconstruction output 520 of the reading order reconstruction module. As shown in FIG. 5A, at a first point in time, the ROI detection module uses low-resolution image data (e.g., a thumbnail with an example resolution of 432×576) to detect a ROI, and returns the cropped area from the raw image 3k×4k containing the ROI the cropped full-resolution image data is processed by the ROI detection module to identify the ROI (e.g., the full-resolution image is cropped to include the ROI without non-essential information). At a second point in time, the text detection module uses the output ROI 505 (the cropped full-resolution image data provided by the ROI detection module) to identify one or more word and word bounding boxes (and location and/or coordinates). At a third point in time, the text recognition module uses the detected text output 510 (cropped full-resolution and/or the one or more word and word bounding boxes provided by the text detection module) to recognize the text within the bounding boxes. At a fourth point in time, the reading order reconstruction module uses the recognized text output 515 (the recognize the text within bounding boxes provided by the text recognition module) to determine a reading order for the words in their respective paragraphs and locations.

FIG. 5B shows an example output of the reading order reconstruction module. The reading order reconstruction module determines word groups and/or paragraphs, as well as a word reading order, word group reading order, and/or paragraph reading order text within contextual data. As shown in FIG. 5B, at a first process 550 includes associating words with individual bounding boxes, and a second process 555 includes identifying word groups and/or paragraphs (e.g., words that are determined to be a combination of words, or words that are determined to remain together), associating the word groups and/or paragraphs with grouped bounding boxes, and ordering the grouped bounding boxes based on reading order and their text locations.

### On-device module Extraction

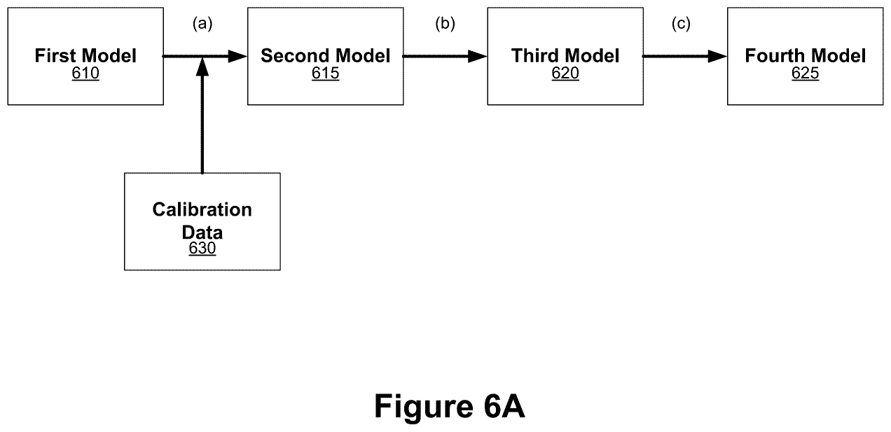

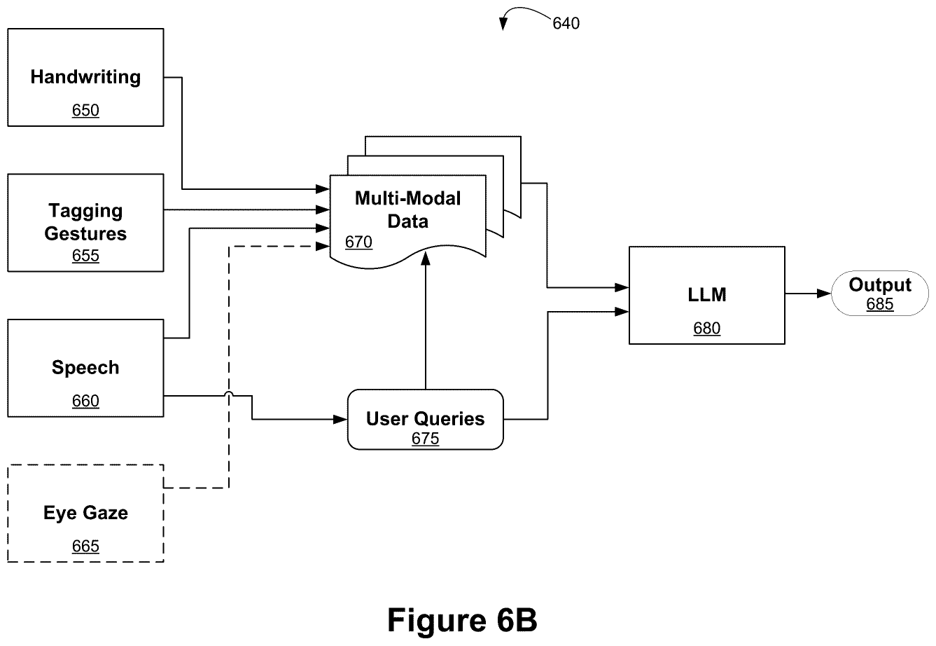

FIG. 6A illustrates a method of exporting a module for on-device implementation, in accordance with some embodiments. For example, the method shown in FIG. 6A can be used to export the STR module 435 onto a wearable device (e.g., the head-wearable device 110) or edge device, such that the STR module 435 is usable at the wearable device or the edge device. The method includes providing a first model 610 having a first precision (e.g., a 32-bit floating-point number (FP32) model), and at a first point (a), performing quantization (a model compression technique) on the first model 610 to generate a second model 615 having a second precision, less than the first precision. For example, quantization can compress the first model 610 from FP32 to an 8-bit integer (INT8) model or 4-bit integer (INT4) model. The first model 610 can be calibrated using calibration data 630 during, before, and/or after quantization. Quantization (e.g., to INT8) saves inference latency and runtime memory. Non-limiting examples of quantization techniques include (dynamic) post-training quantization (PTQ), quantization-aware training (QAT), quantized low-rank adaptation (QLoRA), pruned and rank-increasing low-rank adaptation (PRILoRA), etc.

The method further includes, at a second point in time (b), transferring the second model 615 from a first model type to a second model type (e.g., a third model 620). The third model 620 includes the same precision as the second model 615; however, the third model 620 is converted to a format or code executable by one or more processors of a wearable device. At a third point in time (c), the third model 620 is optimized to generate a fourth model 625. The fourth model 625 is configured to use hardware accelerators. In some embodiments, the fourth model 625 is a quantum neural network model. The fourth model 625 is configured to operate on the wearable device.

### AI Assistance for Conversations

FIG. 6B illustrates an example system for providing AI assistance on conversations, in accordance with some embodiments. The example system 640 can be included in one or more wearable devices, such a wrist-wearable device 120 and a head-wearable device 110 (FIGS. 1A-3E), and/or any other electronic devices described herein (e.g., such as devices shown and described below in reference to FIGS. 16A-16C).

As shown in FIG. 6B, the example system 640 receives one or more of handwriting data 650, tagging gestures 655, speech data 660, and (optionally) eye gaze data 665 to generate multi-modal data 670 and user queries 675. The multi-modal data 670 and user queries 675 are provided to an LLM 680 of the example system 640 to generate an output 685 (e.g., an AI assistant response). The multi-modal data 670 and user queries 675 generate a comprehensive conversation history that enable the AI assistant to access and synthesize information without additional inputs from the user. The output 685 can by any type of AI assistant response. Non-limiting examples of the output 685 include a summary generated by the AI assistant, information retrieved by the AI assistant, action items extracted by the AI assistant and identification of next steps, insights identified by the AI assistant by synthesizing and analyzing key information, identification of focus areas to promote learning (e.g., areas for additional study), etc.

For example, similar to FIG. 3C, a user can be in a meeting with a colleague while a wearable device obtains data. The one or more wearable devices can obtain handwriting data 650 while the user takes notes and/or from notes drawn on a white board; obtain tagging gestures 655 from annotations or tags made by the user in their notes and/or drawn on a whiteboard and/or pointing gestures to particular objects or regions of interests (by the user or others in a field of view of the user); obtain speech data 660 through conversations by the user, the colleague, presenters, and/or other bystanders; and obtain gaze data 665 through the user's interaction and participation in the meeting. The example system 640 process, interprets, and records the handwriting data 650, tagging gestures 655, speech data 660, and eye gaze data 665, which allows the AI assistant to store, playback, and query about the multi-modal data 670. The obtained data can be timestamped to allow for synchronization and improved searching. For example, if the user wants to go back to a follow-up item mentioned during the meeting, they can simply ask the LLM-based interface (e.g., LLM 680) to search for the moment, and bring up all the related information.

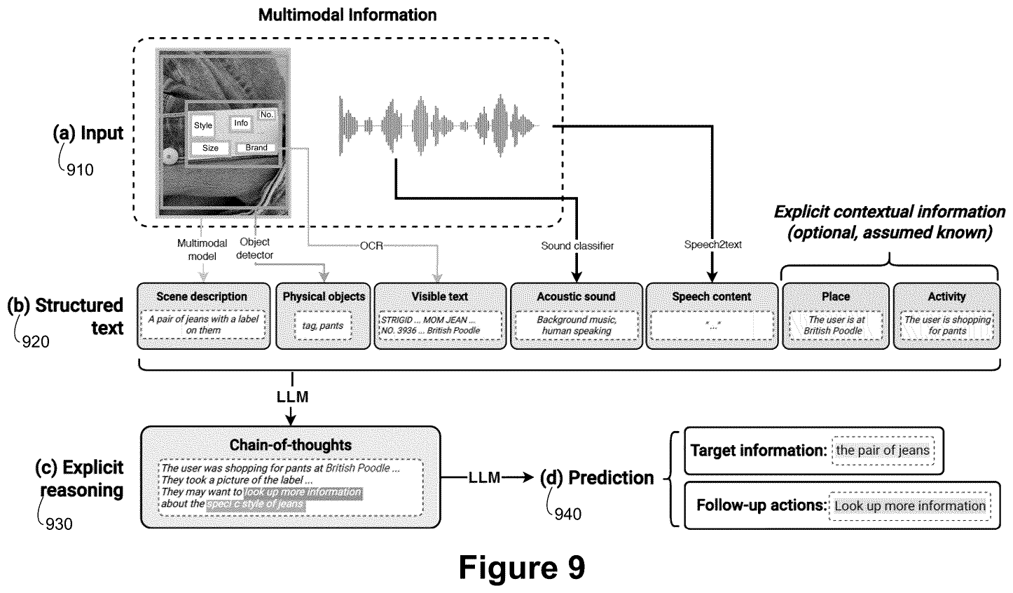

The handwriting data 650 and the tagging gestures 655 can be obtained via neuromuscular-signals captured by one or more neuromuscular-signal sensors (e.g., EMG sensors) of a wrist-wearable device 120 and/or image data captured by an imaging device (e.g., camera) of the wrist-wearable device 120, the head-wearable device 110, or other communicatively coupled device. The speech data 660 can be obtained audio data captured by a microphone or other audio sensor of the wrist-wearable device 120, the head-wearable device 110, or other communicatively coupled device. The gaze data 665 can be captured via imaging devices of the wrist-wearable device 120, the head-wearable device 110, or other communicatively coupled device, or by one or more eye tracking sensor of the head-wearable device 110. The handwriting data 650, tagging gestures 655, speech data 660, and the eye gaze data 665 can be processed by one or more of the ASR module 440, STR module 435, optical character recognition module, sound classifier model and/or other models described in reference to FIGS. 4 and 9.

The example system 640 allows users to concentrate on being an active participant in an event or meeting without having to do anything beyond their natural note taking and meeting behaviors. The user does not have to break away from the meeting to prepare a recording or capture missed notes. Additionally, the example system 640 provides an efficient solution for revisiting past meetings as all the contents will be automatically digitalized. Further, the example system 640 allows users to focus on portions of the meeting or related sections that they tagged as interesting or challenging, and keeps a record for everyone who were in the collaboration.

### AI system for Recommending Follow-Up Actions

FIG. 7 illustrates a system for recommending follow-up actions, in accordance with some embodiments. The follow-up action recommendation system 700 shows generation of a design space and use of an AI assistant system (e.g., including an MM-LLM) for predicting and providing follow-up actions to a user. One or more modules or components of the follow-up action recommendation system 700 are included on a wearable device, such as a head-wearable device 110, a wrist-wearable device 120, or other devices described herein. In some embodiments, a first set modules and/or components of the follow-up action recommendation system 700 are included on-device and a second set modules and/or components of the follow-up action recommendation system 700 are included off-device (e.g., server-side components). Alternatively, or in addition, in some embodiments, the components and/or modules of the follow-up action recommendation system 700 are on a single device.

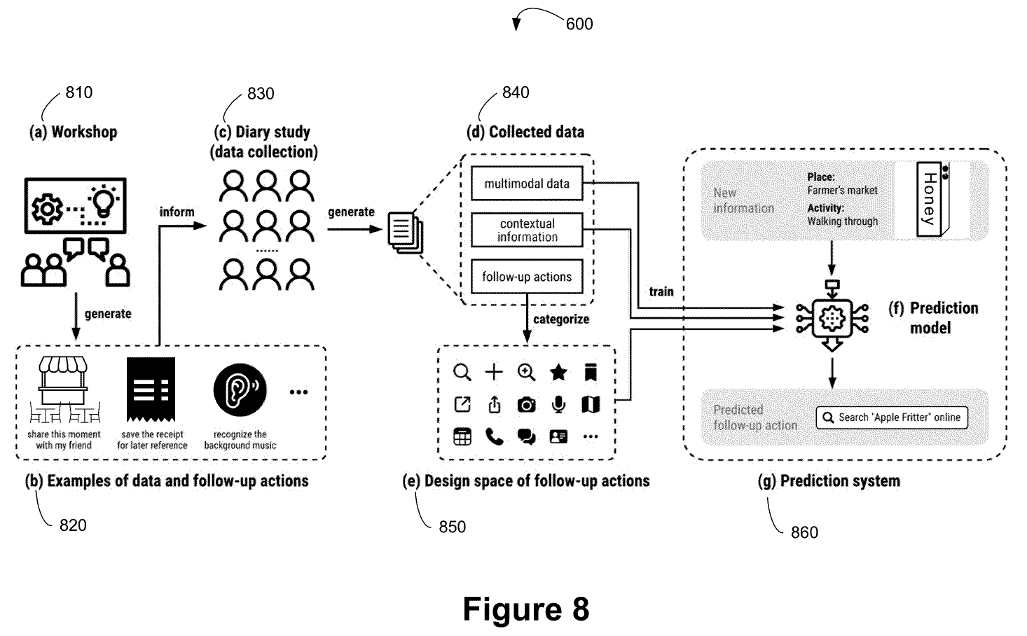

The follow-up action recommendation system 700 includes a data collection phase 710. The data collection phase 710 collects data from one or more users during a predetermined period of time (e.g., a five-day diary study). The data collected from the one or more users includes one or more of intended action to be performed on captured image data and/or audio data, messages, webpages etc., as well as desired action to be performed on the captured image data and/or audio data, messages, webpages etc. In some embodiments, the data collected from the one or more users includes contextual information associated with the action (e.g., time or day, contact relation, content origin (e.g., social media application, news media application, etc.), etc.). Additional information on the collected data is provided below in reference to FIG. 8.

The follow-up action recommendation system 700 includes a design space phase 720. The design space phase 720 generates follow-up actions (to be performed on digital content, such as image data, audio data, messages, webpages, etc.) based on the data collected from the one or more users during the data collection phase 710. In some embodiments, the follow-up action included in the design space phase 720 are updated based on a follow-up data collection phase 710. Alternatively, or in addition, in some embodiments, the follow-up action included in the design space phase 720 are updated based on follow-up actions selected by a user (from a set of predicted follow-up actions). Non-limiting examples of the follow-up actions include sharing digital content, saving digital content, generating reminders, searching or looking up digital content, extracting information from digital content, manipulating digital content, and/or complex actions (e.g., custom follow-up actions, sequential follow-up actions, follow-up actions performed in parallel, etc.).

The follow-up action recommendation system 700 includes an AI processing phase 730. The AI processing phase 730 uses an AI model or AI assistant system (e.g., AI assistant system 400 or a variation thereof), to process multimodal sensor inputs 735 (e.g., analogous to contextual data as described above in reference to FIGS. 1A-5B) and determine context 737 and/or contextual cues. For example, the AI processing phase 730 uses received image data, audio data, and/or sensor data to determine a context and/or contextual cues (e.g., location, time, temperature, and/or purpose of user activity) that are inputs to an MM-LLM. In some embodiments, the multimodal sensor inputs 735 and the context 737 are used to generate a prompt that is provided to the MM-LLM. The MM-LLM uses, at least, the multimodal sensor inputs 735 and the context 737 to determine and provide predicted outputs 740. In some embodiments, the MM-LLM uses target information (e.g., portions of the contextual data identified as an ROI or object of interest based on contextual cues).

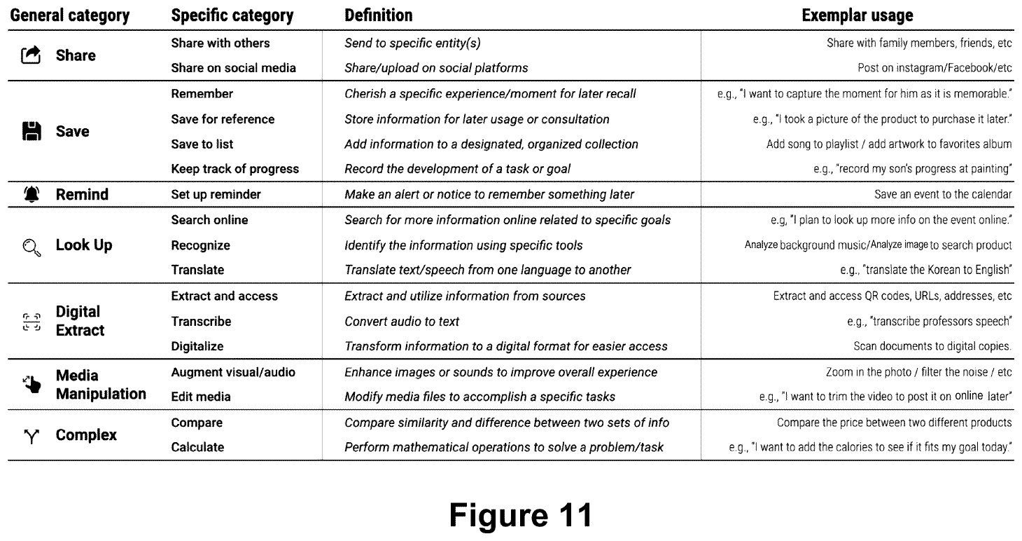

The predicted outputs 740 include digital actions that a user may want to perform on digital content provided to the follow-up action recommendation system 700. For example, in FIG. 7, the AI model or AI assistant system (e.g., represented by the AI processing phase 730) uses an image of a grocery shelf and contextual information indicating that the user is shopping at a grocery store to recommend a set of predicted outputs recommending follow-up actions on target information, such as using a search engine to look up additional information on a product brand within the image data, sharing an image with contacts of the user, and/or sharing a price of a product brand within the image data. As shown in FIG. 7, conversations can be used by the follow-up action recommendation system 700 to predict and provide a set of predicted outputs recommending follow-up actions. For example, the AI assistant system (e.g., represented by the AI processing phase 730) uses audio data of a conversation of over background music and contextual information indicating that the user is traveling by car to recommend a set of predicted outputs recommending follow-up actions on target information, such as recognizing and/or using a search engine to look up additional information on the background music; transcribing the conversation, and/or saving the background music to a playlist of the device. Additional examples of follow-up actions are provided below in reference to FIG. 11.

### Training of Follow-Up Action Recommendation System

FIG. 8 illustrates example training of a follow-up action recommendation system, in accordance with some embodiments. The follow-up action recommendation system training process 800 includes a data collection phase (e.g., a workshop 810). The data collection phase is used to generate informative examples of situations when a user may take and/or use multimodal information. The informative examples can be used to assist a user providing inputs into a diary study (e.g., a data set that is used for predicting a user's particular desired actions to be performed on particular data).

The data collection phase is used to generate 820 examples of data and follow-up actions, which include data on when participants intended or wished to take an action using multimodal data. The generated examples of data and follow-up actions are used to supplement a diary study phase 830. The examples of data and follow-up actions and the diary study data form collected data 840. The collected data 840 includes multimodal data, contextual information, and follow-up actions. The collected data 840 is analyzed to determine and categorize follow-up actions for a user. The analyzed and categorized follow-up actions are included in a design space 850 (as described above in reference to FIG. 7). The follow-up actions and the collected data are used to train a prediction system 860 (e.g., an AI model or AI assistant of AI processing phase 730) of the follow-up action recommendation system 700 described above in reference to FIG. 7.

In some embodiments, the diary study includes two phases (e.g., an introductory phase and a diary phase). During the introductory phase, a user is shown examples from the workshop that represented several of the categories of media and actions that have been previously identified (e.g., popular or common actions). In order to avoid bias due to previous categorization of follow-up actions, in some embodiments, a user is only shown example media and follow-up actions. During the diary phase, a user is instructed to provides at least two entries within a predetermined time period (e.g., two entries a day). In some embodiments, a user is requested to provide entries for one or more days (e.g., two entries each day for five days). Entries provided by the user reflect genuine participant needs that occurred in a moment. Non-limiting examples of the prompts or questions provided to a user during the dairy phase are provided below.

Diary queries can request information about collected media (e.g., audio data and/or image data). In particular, to protect a user's privacy, the diary queries request that the user provide a textual description of the collected media. The textual description can be brief (e.g., a sentence, a word, etc.). As the diary information is configured to maintain anonymity, the textual responses reduce the capture of potentially identifiable personal information. The diary queries can request contextual information (e.g., locations, nearby landmarks, nearby objects, nearby people, and/or changes thereof). In some embodiments, to predict follow-up actions, a user's location and (ongoing) activity are used to determine how a user would interact with the contextual information.

In some embodiments, the diary queries can request user desired target information. In particular, to accurately train the follow-up action recommendation system, during a training phase a participant is asked for user desired target information (e.g., what information is important for them). For example, a user can be interested in only the text visible in an image or the entire scene and can be asked which they desired. Similarly, a user can be asked to identify objects visible in an image or sounds that can be heard from audio data and identify which information they desired. The user desired target information provides additional context to achieve a better understanding of potential user interactions with the data provided to the follow-up action recommendation system.

In some embodiments, the diary queries can request actions to be taken. Specifically, a user can be asked to use natural language to describe the actions they intended to take and then categorize these actions. In some embodiments, the user can select categories corresponding to the actions using the action categories identified in the workshop. In some embodiments, a user has the option to create new categories by selecting ‘other’ if there were actions that did not fit within the existing categories. In order to minimized potential bias, a user is asked to detail their intention and desired actions in their own words on before being presented and asked to choose from the action types. User selected categories that are later used as a reference point during the iteration towards a trained follow-up action recommendation system are presented in a design space. In some embodiments, the diary queries can request a user's high-level goals and reasoning to better understand why a user intended to take a particular follow-up action (e.g., asking a user to share their high-level goals and reasons for doing so).

The follow-up actions recommended by the follow-up action recommendation system are configured to reduce friction in performing actions in response to situations or events (e.g., make it easy for a user to experience a moment, as well as perform digital actions associated with the particular moment). The follow-up action recommendation system enables the simultaneous processing of multimodal sensory inputs and subsequent generation of follow-up action predictions on target information. As described below, in some embodiments, the follow-up action recommendation system utilizes one or more models to convert multimodal sensory inputs into structured text and determine, based on the structured text, explicit reasoning on the structured text to predict target information and follow-up actions (e.g., based on follow-up actions in a design space).

### Example Follow-Up Action Prediction

FIG. 9 illustrates example inputs to a follow-up action recommendation system, in accordance with some embodiments. The follow-up action recommendation system processes different multimodal information, and predicts target information and follow-up actions grounded in the action/design space (which is based on previously captured user data, such as diary studies and workshop data as described above in reference to FIGS. 7 and 8). By reasoning with multimodal and contextual information, the follow-up action recommendation system is configured to enhance explain-ability and overall performance.

For example, as shown in FIG. 9, the follow-up action recommendation system receives (raw) multimodal information (e.g., image data, audio data, sensor data, etc.) as an input 910. The multimodal information is provided to one or more models to determine structured text 920 (e.g., a structured textual representation of contextual data or other data provided by the user to the AI assistant). In particular, the follow-up action AI assistant system converts the multimodal information into a textual representation (and, in some embodiments, audio representation). In some embodiments, the multimodal information is converted into structured text simultaneously. The structured text is a representation and has a unified representation format (e.g., a textual representative or a joint embedding space) of the converted multimodal information, which enables a model to identify and learn from patterns in the multimodal input.

The structured text can include scene descriptions (e.g., textual descriptions of a scene captured in image data and/or a field of view of the user (e.g., using a multimodal model)), physical object descriptions (e.g., textual descriptions of physical objects captured in image data and/or a field of view of the user (e.g., determined using object detection models)), visible text recognition (e.g., texted identified using optical character recognition (OCR) or textual descriptions including text identified using OCR (e.g., definitions of or additional information on identified text)), acoustic sound descriptions (textual descriptions of ambient or background sounds including background music, human speed, white noise, brown noise, etc. (e.g., determined using a sound classifier model)), speech transcriptions (e.g., textual descriptions or transcriptions of user speech, user queries, or other user dialogue (e.g., based on speech to text models, such as “Speech2text”)), location descriptions (e.g., textual descriptions of a location of a user, a landmark or public location at which the user is located, etc. (e.g., determined from meta data, GPS, or other sensor data shared by the user or inferred through the multimodal information or shared by the user)), activity description (textual descriptions of actions or activities performed by the user (e.g., inferred through the multimodal information or shared by the user and/or contextual data or other data provided by the user). In some embodiments, the structured text 920 is an example of one or more contextual cues. As described below, the structured text allows models to generate explicit reasoning for predictions.

The one or more models of the follow-up action recommendation system include captioning models, object detection modes, text recognition models, and/or other models for extracting data from image data. Additionally, or alternatively, the one or more models of the follow-up action recommendation system include sound classifier models, speech-to-text models, and/or other models for extracting data from audio data. While the multimodal information described in reference to FIG. 9 include image data and/or audio data, the multimodal information can include other data not listed, such a biometric data, eye-tracking data, hand-tracking data, information provided from other user, alerts, and/or any other type of data received from sensors.

The explicit contextual information can be used to determine type of actions that users perform for a particular scenario. For example, where a user is and what the user is doing when the multimodal information is provided to the follow-up action recommendation system effects the type of actions a user would like to perform with the target data. In some embodiments, contextual information is optional.

The follow-up action recommendation system provides the structured text of an MM-LLM to determine explicit reasoning 930. In particular, the follow-up action recommendation system performs intermediate explicit reasoning on the structured text via a Chain-of-Thoughts (CoT) prompting model. The training data for CoT prompting model is based on previously captured user data (e.g., diary study data described above in reference to FIGS. 7 and 8). The CoT prompting model is configured to provide an output that explains the rationale behind its predictions for certain follow-up actions. The explanation generated by the CoT prompting model should be as close to a user's reasoning as possible to accurately determine target information and follow-up actions for the user. For example, a user can capture an image with multiple texts (including the brand name, the jean's name and the size etc.), but the user may only intend to search more information about the specific jean's sizes, rather than the brand name—accurate reasoning can help in deciding which target information to search.

In some embodiments, the CoT prompting is performed an intermediate reasoning step through the prompting and training process. As describe above, in some embodiments, the CoT model is trained based on previously captured user data (e.g., diary data including high-level goals and reasoning) to understand the rationale behind their intended follow-up actions. In some embodiments, the user data is converted from first-person perspective to third-person perspective for the CoT prompts. For example, “I found a pair of pants that fit me well and I liked the style, but I didn't like the holes in the pants. I wanted some without holes. So, I took a pic of the size and style and plan to look it up online to see if there are any other options I like better” is converted to “the user was shopping for pants at British Poodle and found a pair they might like. They took a picture of the label, which includes the style and size of the jeans. They may want to look up more information about the specific style of jeans, such as reviews or other colors available.”

In some embodiments, the generated CoT prompts for the model are used as a ground truth label for each data point collected during the diary study. Specifically, the prompt consisted of the list of actions with the respective description ground truth action label and the user's responses for their goals and reasons.

The follow-up action recommendation system further predicts 940 the target information (i.e., the whole scene, physical objects, text, sounds, or speech) and the follow-up actions grounded in the design space using another (or the same) MM-LLM.

The follow-up action recommendation system and the AI assistant system disclosed herein help users multitask and/or carry out additional actions while busy. As an example, the AI systems disclosed herein allow a user to carry a conversation with a friend while at the same looking up a meaning of a parking sign and/or searching for a restaurant while chatting with a friend. The AI systems disclosed herein proactively serve user needs with actions and suggestions so that friction and cognitive load is reduced for users. The contextual data provided to the AI systems can be used to answer user questions on-the-go, as well as carry out actions with parameter values generated from a conversation and/or other contextual data.

### Example Head-Wearable Device Including a Follow-Up Action Recommendation System

FIGS. 10A-10D illustrate a follow-up action recommendation system included on a wearable device, in accordance with some embodiments. In FIGS. 10A-10D, the follow-up action recommendation system is initiated at a wearable device (e.g., head-wearable device 110 or AR glasses 1628). Alternatively, or in addition, in some embodiments, the follow-up action recommendation system is initiated via another device communicatively coupled with the head-wearable device 110, such as the wrist-wearable device 120, a mobile device 1650, or other device of an XR system. In FIG. 10A, a user provides contextual data to the follow-up action recommendation system. The user is able to select the type of contextual data provided to the follow-up action recommendation system, such as visual data, audio data, sensor data, etc. The follow-up action recommendation system identifies an ROI (as described above in reference to FIGS. 1A-5B) or target information (as described above in reference to FIGS. 7-9) for determining a follow-up action.

In FIG. 10B, the follow-up action recommendation system processes image data provided by the user. The follow-up action recommendation system analyzes the captured image data to determine target information (e.g., the product name—Farmer's Honey) and follow-up actions based on the target information. The follow-up action are presented to the user via the head-wearable device 110 and/or other communicatively coupled device. For example, head-wearable device presents, via a display, follow-up action UI elements related to the target information including a share UI element, a save UI element, a search UI element, and/or request additional options UI element.

In FIG. 10C, the user selects the search UI element. The head-wearable device 110, the AI assistant system, and/or the follow-up action recommendation system perform a search using the targe information. For example, as shown in FIG. 10D, the head-wearable device 110, the AI assistant system, and/or the follow-up action recommendation system present search results to the user based on the target information (e.g., Farmer's Honey is “Honey from New Zealand. The honey is known for its smoky and spicy flavor”). As described above, the follow-up action recommendation system is configured to reduce user friction in identifying key information from multimodal data and performing specific actions based on the key information.

### Example Follow-Up Actions

FIG. 11 illustrates example follow-up actions, in accordance with some embodiments. Non-limiting examples of the follow-up actions include sharing target information, storing (or saving) target information, setting up reminders based on target information, looking up (or performing a search) based on target information, extracting data from the target information, media manipulation based on the target information, and/or performing complex operations on the target information. One or more follow-up actions can be performed individually, sequentially, or together. In some embodiments, the follow-up actions are generated based on prior user history and/or previous inputs. In some embodiments, the follow-up actions presented in order based on relevance (e.g., captured images are presented with sharing follow-up actions and captured audio are presented with search follow-up actions).

### Natural Language Processing on a Wearable Device

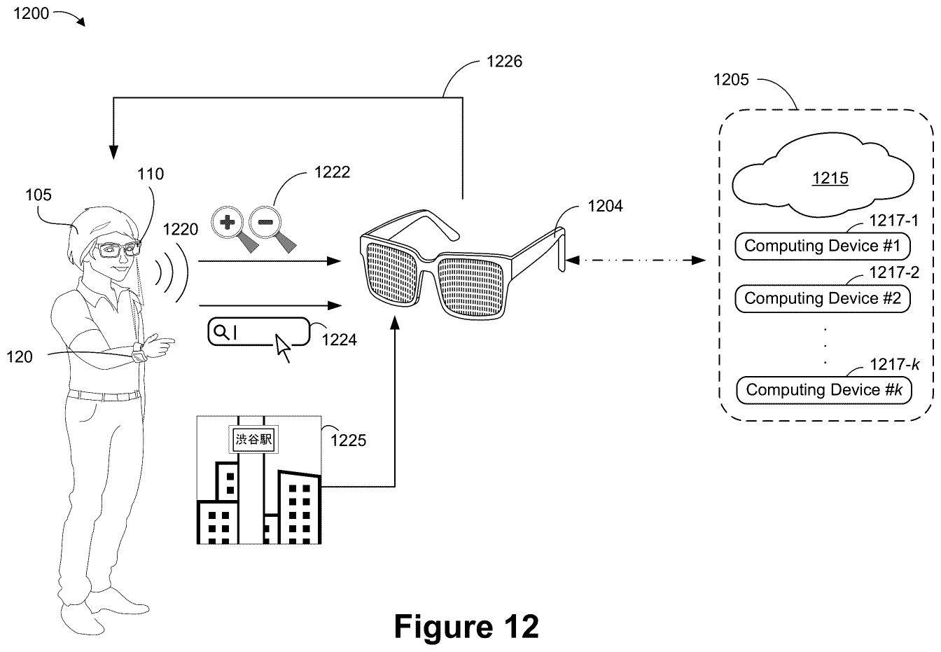

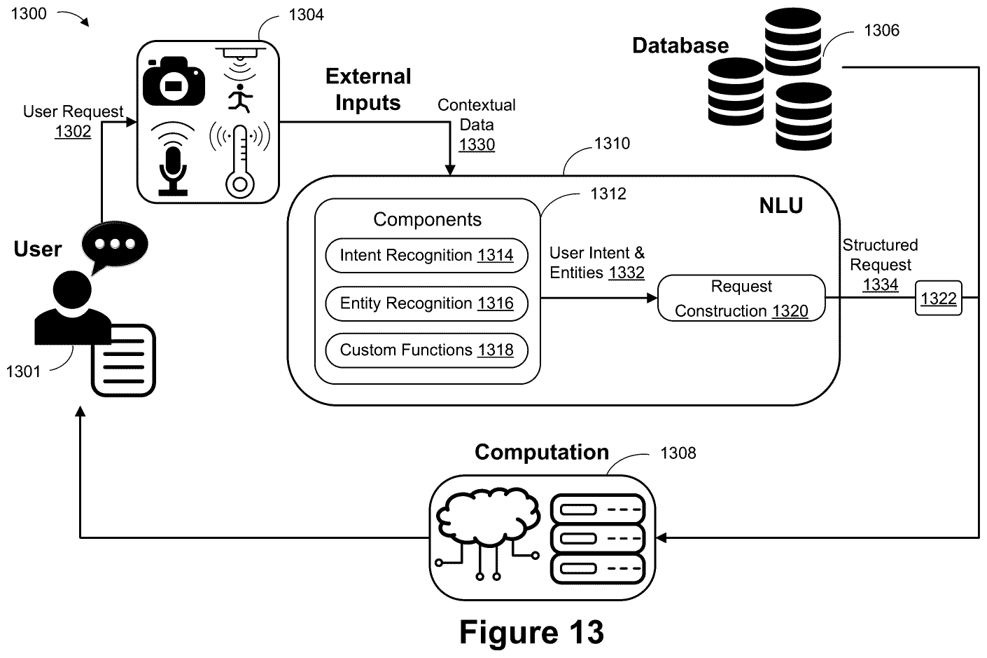

FIG. 12 illustrates natural language processing system performed on a wearable device, in accordance with some embodiments. The wearable device, such as a head-wearable device 110 and a wrist-wearable device 120, can be part of an XR system described below in reference to FIGS. 16A-16C-2. The wearable device is configured to capture and/or receive contextual data (e.g., image data, audio data, sensor data, etc.) and process the contextual data to identify user requests or queries, user intent, words, sentences, keywords, and/or other linguistic characteristics in the contextual data. The wearable device processes a portion of the contextual data using an on-device module (natural language understanding (NLU) module 1310; FIG. 13) that is optimized to process contextual data efficiently and quickly. The NLU module 1310 can have a reduced size and/or utilize hardware accelerators to process the contextual data. For example, the NLU module 1310 can have a total size less than or equal to 20 MB, less than or equal to 10 MB, less than or equal to 5 MB. The natural language processing system 1200 can be part of and/or used in conjunction with the AI systems described above in reference to FIGS. 1A-10D. The wearable device can further use one or more off-device modules. The wearable device can provide contextual data to an off-device portion is facilitated by one or more networks 125 and a plurality of computing devices (e.g., computing devices 1217-1, 1217-2, . . . , 1217-k, such as a server 1630, a computer 1640, etc.) that are communicatively coupled to the wearable.

The NLU module 1310 processes contextual data to facilitate human-computer interaction and improve system efficiency. The NLU module 1310 generates, based on the contextual data, an identification of user requests or queries, an understanding of sentiments expressed by speech in the contextual data, identification of user reasoning for requests or queries, identification of user intent, a mapping of the user intent to one or more requests or user queries, an identification of contextual cues, etc. As discussed below, the generated output of the NLU module 1310 is used to orchestrate one or more tasks (e.g., identifying tasks to be performed on-device and/or off-device modules). The NLU module 1310 can combine computational linguistics, machine learning, and/or deep learning models to process human language for understanding user linguistic inputs in various forms such as voices, sentences, and words. The NLU module 1310 can further improve interaction between an AI assistant and the user 105 (e.g., formulating a response to a request).

As shown by the natural language processing system 1200, a head-wearable device 110 worn by a user 105 can receive a voice input 1220. The NLU module 1310 can analyze the voice input 1220 (and/or other contextual data) to determine whether a query trigger cue is detected (e.g., “Hey” or “Hey Virtual Assistant”), and, if a query trigger cue is detected, the NLU module 1310 processes the voice input 1220 to determine, at least, a request. Alternatively, if a query trigger cue is not detected, the NLU module 1310 forgoes processing contextual data (e.g., until a query trigger cue is detected). In some embodiments, the AI assistant is initiated responsive to a user input, initiated in conjunction with detection of the query trigger cue, or initiated responsive to a determined request. The NLU module 1310 can determine any number of requests, such as a first request 1222 to initiate image sensor and/or adjust image capture setting (e.g., “Assistant, zoom in before taking the picture”), a second request 1224 to perform a web search (e.g., “Assistant, please look up when the restaurant opens”), a third request 1225 to analyze captured image data for additional information (e.g., Assistant, what does this sign say? “). The NLU module 1310, in determining the request, can generate output that is used to determine whether a response to the request (and/or associated tasks) can be generated using on-device modules and/or off-device modules.

The on-device modules and/or off-device modules are selected based on the output generated by the NLU module 1310. In particular, the output of the NLU module 1310 is used to determine whether the response to the request can be prepared on the head-wearable device 110, on another device communicatively coupled with the head-wearable device 110, or a combination thereof. For example, the output of the NLU module 1310 can be used to determine whether processing criteria are satisfied and, the head-wearable device 110, based on satisfaction of the processing criteria, selects one or more devices for preparing the response. In some embodiments, the head-wearable device 110, in accordance with determination that a first subset of the processing criteria are satisfied, selects an on-device module (e.g., a lightweight machine-learning model (e.g., a lightweight MM-LLM)) for preparing the response. In some embodiments, the head-wearable device 110, in accordance with determination that a second subset of the processing criteria are satisfied, selects an off-device module (e.g., a (full) machine-learning module) for preparing the response. In some embodiments, the head-wearable device 110, in accordance with determination that a third subset of the processing criteria are satisfied, selects an on-device module and an off-device module for preparing the response.

The processing criteria can include one or more of the request, tasks associated with the request, expected computational usage, power consumption, accuracy threshold, latency threshold, machine-learning model availability, etc. As a non-limiting example, the first subset of the processing criteria can include a first predetermined number of criteria; the second subset of the processing criteria can include a second predetermined number of criteria greater than the first predetermined number of criteria; and the third subset of the processing criteria can include a third predetermined number of criteria greater than the second predetermined number of criteria. Alternatively, or in addition, in some embodiment, one or more of the on-device modules and/or off-device modules are selected based on a magnitude that a threshold is not satisfied.

The request and/or one or more associated tasks are provided to the selected on-device modules and/or off-device modules. For example, the first request 1222 includes one or more tasks for controlling an image sensor of the head-wearable device 110, and the tasks for controlling the image sensor of the head-wearable device 110 are provided to on-device modules of the head-wearable device 110. The second request 1224 to perform a web search includes one or more tasks for interpreting a search query and using a search engine on the head-wearable device 110, the tasks for interpreting a search query can be provided to on-device and/or off-device modules and the tasks for using a search engine on the head-wearable device 110 can be provided to on-device modules. For example, the NLU module 1310 can process a portion of the voice input 1220 to interpret a search query and in accordance with a determination that the interpretation of the search query would satisfy a respective processing criteria assign the interpretation task to selected on-device module and/or off-device modules based on the satisfied processing criteria. The third request 1225 to translate a portion of image data includes one or more tasks for detecting and translating an ROI, the tasks for translating the portion of image data can be provided to on-device and/or off-device modules (e.g., as shown and described above in reference to FIGS. 1A-2C and 4.

By selectively providing tasks to one or more on-device module and/or off-device modules, processing times and latency related to preparation of a response by an AI assistant can be reduced. Additionally, selectively providing tasks to one or more on-device module and/or off-device modules can extend the battery life of a wearable device.

### Example Natural Language Understanding System

FIG. 13 illustrates an example natural language understanding system, in accordance with some embodiments. A first example natural language understanding system 1300 presents a high-level configuration of a NLU pipeline architecture with periphery components (e.g., external inputs 1304, databases 1306, and computing element(s) 1308). A user 1301 provides a user request 1302, which is captured as contextual data 1330 by external inputs 1304 (e.g., image sensors, microphones, sensors, etc.). The contextual data 1330 is provided as an input to an NLU module 1310 and generates a structured request 1334 as an output. As described above, the NLU module 1310 can be included in a wearable device. The structured request 1334 can include an interpretation of the user request, a user intent, a mapping of the user intent to the request (and/or associated tasks), etc.

The NLU module 1310 uses the contextual data 1330 to determine user intent and entities 1332. The user intent and entities 1332 are determined using one or more components 1312, such as an intent recognition component 1314, an entity recognition component 1316, a custom functions component 1318. The intent recognition component 1314 is configured to detect, determine, and classify a user intent according to the contextual data 1330. Specifically, the intent recognition component 1314 identifies actions that the user wants to accomplish based on the contextual data 1330. The entity recognition component 1316 is configured to recognize entities or extract entities according to the contextual data 1330. Specifically, the entity recognition component 1316 is configured to capture entities in the contextual data 1330 (e.g., voices, texts, images, etc.). Entities can be in forms of objects, such as numbers, dates, times, locations, or any other predefined categories. The custom functions component 1318 includes additional functions that supplement the intent recognition component 1314 and the entity recognition component 1316. For instance, the custom functions component 1318 can include a sentiment analysis function (e.g., for determining sentiment or emotion expressed the contextual data 1330) and a syntax parsing function (e.g., for analyzing grammatical structure of sentences, captured from the contextual data 1330, to understand relationships between words and phrases). In another instance, the custom functions component 1318 can include an intent ranking function that is configured to rank or group possible user intent and entities 1332 associated with the contextual data 1330 based on their likelihood or relevance, as there may be more than one interpretation on the contextual data 1330.

A request construction component 1320 uses the user intent and entities 1332 to map the user intent and entities 1332 and the contextual data 1330 to the user request 1302 and form the structured request 1334. The structured request 1334 can be a data set is formatted to be used with one or more machine-learning models and/or that can be understood and executed by computer devices. For example, the structured request 1334 can include specific keywords, parameters, or constraints for machine-learning models and/or computer devices. In some embodiments, the structured request 1334 is provided to a module selection component 1322. Alternatively, in some embodiments, the module selection component 1322 is part of the request construction component 1320. The module selection component 1322 is configured to determine and/or select one or more on-device and/or off-device modules for performing a request and/or associated tasks. In some embodiments, selected on-device and/or off-device modules for request and/or associated tasks are stored within the structured request 1334.

The module selection component 1322, as described above, determines on-device and/or off-device modules and/or other components for executing the structured request 1334. In particular, the module selection component 1322 determines processing criteria satisfied by the request and/or associated tasks, and selects on-device and/or off-device modules and/or other components for performing the request and/or associated tasks based on the satisfied processing criteria. For example, the request construction component 1320 can determine, based on the satisfied processing criteria, whether the request and/or associated tasks belong to either a first group of tasks (e.g., on-device tasks) or a second group (e.g., off-device tasks), and provide the request and/or associated tasks to respective groups based on the satisfied processing criteria. Alternatively, to conserve computational resources or battery life of a wearable device, the module selection component 1322 can cause all tasks to be performed off-device. In some embodiments, to protect user privacy, the module selection component 1322 can cause all tasks to be performed on-device.

To perform operations associated with the structured request 1334, the wearable device and/or the computing element(s) 1308 are configured to receive the process the structured request 1334 from the NLU module 1310. The wearable device and/or computing element(s) 1308 are also configured to receive additional data, if needed, from the databases 1306. The wearable device and/or computing element(s) 1308 are further configured to perform operations associated with the structured request 1334 and/or the additional data and relay respective results to the user 1301.

### Example On-Device Natural Language Understanding System

FIG. 14 illustrates an example on-device natural language understanding system, in accordance with some embodiments. In particular, the on-device natural language understanding system 1400 shows an NLU module 1310 on a wearable device 1401 (e.g., a head-wearable device 110) including one or more periphery components, such as one or more sensors (e.g., first sensors 1412, second sensor 1410, third sensor 1411), computing elements 1420, databases 1426, etc. The wearable device 1401 is communicatively coupled with one or more computing devices 1424 (e.g., computing devices 1424-1, 1424-2, . . . , 1424-k) via one or more networks 1422. The computing devices 1424 can include servers 1630, computers 1640, mobile devices 1650, and/or other electronic devices described below in reference to 16A-16C-2. The computing devices 1424 include one or more off-device modules.

The wearable device 1401 detects user input via the one or more sensors, and responsive to a query trigger, initiates an AI assistant and processes the sensor data to detect a request, if any, and prepare a response to the request. For example, the user may verbally instruct a head-wearable device 110, to “summarize the right page of the book for me,” and the head-wearable device 110 utilizes the sensor data to detect the page of the book and analyze the page contents to prepare a response for the user. The one or more tasks associated with completing the request are identified and distributed to one or more on-device and/or off-device components based on processing criteria. The NLU module 1310 determines a structured data output that is used to determine and select on-device and/or off-device components for preparing a response to the request (e.g., a summary of the right page).

As shown by the on-device natural language understanding system 1400, the wearable device 1401 receives one or more of image data 1432, audio data 1430, and/or other sensor data 1431 from the first sensor 1412, second sensor 1410, and third sensor 1411 respectively. In some embodiments, the image data 1432, audio data 1430, and/or other sensor data 1431 are pre-processes via one or more pre-processing modules (e.g., first, second, and third pre-processing modules 1416, 1414, and 1415). The one or more pre-processing modules are configured to format, sample, denoise, normalize, perform feature extraction, and/or other operations on the contextual data (image data 1432, audio data 1430, and/or other sensor data 1431) to prepare the contextual data for use by one or more machine-learning models or computing devices. While the pre-processing modules are shown as separate modules, in some embodiments, the wearable device 1401 includes a single pre-processing module configured to pre-process the contextual data. Alternatively, or in addition, inn some embodiments, the one or more pre-processing modules are included in another module or device. For example, the pre-processing modules can be part of respective sensors and/or part of the NLU module 1310. The pre-processing modules provide the pre-processed contextual data to the NLU module 1310. In some embodiments, the pre-processed contextual data is provided to computing devices 1424. In some embodiments, the contextual data is not pre-processed and the NLU module 1310 is provided raw data. Similarly, in some embodiments, the computing devices 1424 is provided raw data.

As described above in reference to FIG. 13, the NLU module 1310 is configured to determine structured requests based on the contextual data. The structured requests, such as the first structured request 1442 and the second structured request 1444, can identify one or more selected on-device and/or off-device modules for completing a request and/or associated tasks. For example, the request to summarize the right page of the book can be separated into a plurality of task and provided to on-device and/or off-device modules to prepare a response to the request. The structured requests are provided to respective on-device and/or off-device modules for processing. For example, the first structured request 1442 is provided to the computing elements 1420, which includes one or more on-device modules, and the second structured request 1444 is provided to the computing devices 1424, which include one or more off-device modules. The NLU module 1310 can receive prestored data (operation commands, historical data, user settings, device settings, etc.) and/or computational models from databases 1426 to generate the structured requests.

The computing elements 1420 can include one or more processors and/or modules on the wearable device 1401. For example, the computing elements 1420 can include the compression and transfer module 430, STR module 435, and the ASR module 440, and/or other components described above in reference to FIG. 4. The computing elements 1420 can also include one or more components for presenting representations of data to users, such display, speakers, haptic generators, etc. The computing elements 1420 can generate a response based on the first structured request 1442. In some embodiments, computing elements 1420 receives prestored data and/or computational models from databases 1426 to generate the response. The computing elements 1420 can cause the generated response to be presented to the user as a presented output 1450. Alternatively, or in addition, in some embodiments, the computing elements 1420 provides an output, based on the to the first structured request 1442, to the one or more off-device modules to prepare the response to the request. For example, as described above in reference to FIG. 4, in some embodiments, an STR module included 435 on the head-wearable device 110 can detect an ROI and/or one or more words within an image and provide the processed data to an MM-LLM module 460 on a server 1630.

As described above, the computing devices 1424 are devices with additional computational resources and/or larger power supplies. The computing devices 1424 include large computational models that have high power consumption, high peak memory usage, and use a large number of computations resources. The computing devices 1424 can include (full) AI models or machine learning models that are configured to process the second structured request 1442. For example, the computing devices 1424 can include the MM-LLM module 460, a prompt designer module 455, and a TTS module 465. In some embodiments, the computing devices 1424 uses the second structured request 1442, an output from the computing elements 1420, and prestored data and/or computational models from databases 1426 to generate the response. The response generated by the computing devices 1424 (represented by arrow 1448) is provided to the wearable device 1401. The computing elements 1420 consolidate responses generated by the computing elements 1420 and the computing devices 1424. The response generated by the computing devices 1424, the response generated by the computing elements 1420, and/or the consolidated response is presented to the user as the presented output 1450.

The presented output 1450 can include information displayed at a user interface, a dialogue with the AI assistant, an audio and/or visual notification, a TTS response, activation and/or operation of one or more devices and/or applications, and/or other operations available at the wearable device.

The NLU module 1310 improves performance due to its small size and efficient operation. The NLU module 1310 is optimized to quick identify and/or process tasks, and/or distribute tasks to appropriate models to process a request. For example, the NLU module 1310 allows for tasks to be performed on-device if the tasks can be performed with low latency, minimum use of computational resources, and/or low power consumption. Alternatively, the NLU module 1310 provides instructions to perform tasks off-device if the tasks require stronger or powerful models. The NLU module 1310 can be used to distribute tasks to efficiently use available computational resources on-device and off-device, as well as conserve battery life of wearable devices. Additionally, the NLU module 1310 can be used to decrease latency by distributing tasks between on-device and off-device components.

### Example Method Generating Artificially Intelligent Assistant Responses

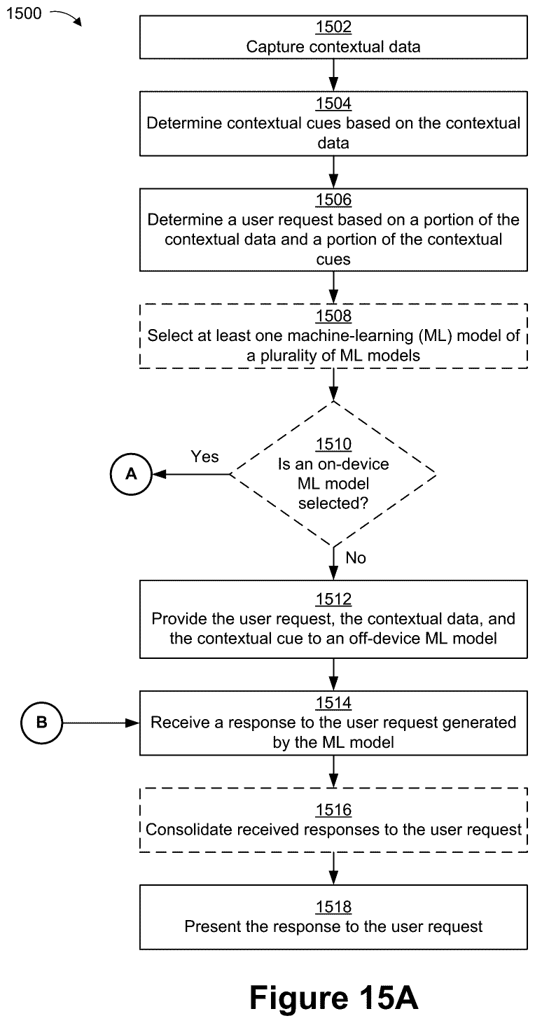

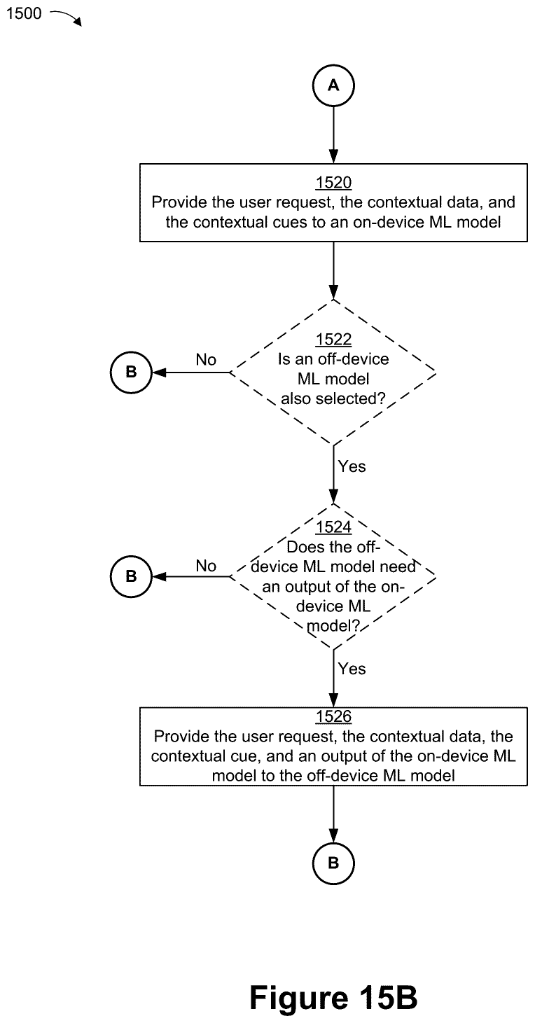

FIGS. 15A and 15B illustrates a flow diagram method of generating a response to a user request using an AI assistant, in accordance with some embodiments. Operations (e.g., steps) of the method 1500 can be performed by one or more processors (e.g., central processing unit and/or MCU) of a wearable device, such as a head-wearable device 110 and/or wrist-wearable device. At least some of the operations shown in FIGS. 15A and 15B correspond to instructions stored in a computer memory or computer-readable storage medium (e.g., storage, RAM, and/or memory). Operations of the methods 1500 can be performed by a single device (e.g., a wearable device or other electronic device described below in reference to FIGS. 16A-16C-2) alone or in conjunction with one or more processors and/or hardware components of another communicatively coupled device and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

The method 1500 is performed at a head-wearable device 110 and includes capturing (1502) contextual data. The contextual data can be captured by one or more image sensors, microphones, and/or other sensors included on the head-wearable device 110. Alternatively, or in addition, the contextual data can be obtained by one or more devices communicatively coupled with the head-wearable device 110. The method 1500 includes determining (1504) contextual cues based on the contextual data and determining (1506) a user request based on a portion of the contextual data and/or a portion of the contextual cues. The contextual data can include one or more image data, audio data, and/or sensor data. The contextual cues can be detected or identified portions of the contextual data related to the user request and relevant for generating a response to the user request. For example, as described above in reference to FIGS. 1A-5B, a contextual cue can be an identification of an ROI, and identification of words, phrases, paragraphs, identification of target objects or information (e.g., store tags, receipts, songs, etc.), location, activity, etc.

In some embodiments, the method 1500 includes selecting (1508) at least one machine-learning (ML) model of a plurality of ML models. For example, as described above in reference to FIGS. 12-14, a head-wearable device 110 can select on-device and/or off-device modules for generating a response to the user request. The method includes determining (1510) whether an on-device ML model selected. In accordance with a determination that an on-device module is not selected (“No” at operation 1510), the method 1500 includes providing (1512) the user request, the contextual data, and the contextual cues to an off-device ML (e.g., an off-device module on a server 1630). The method 1500 further includes receiving (1514) a response to the user request generated by the ML model, and presenting (1518) the response to the user request. Presenting the response can include providing audible dialog, presenting the response on a display, presenting visual and/or audio indication, text-to-speech read outs, etc. In some embodiments, the method 1500 includes consolidating (1516) received responses to the user request as discussed below.

In accordance with a determination that an on-device module is selected (“No” at operation 1510), the method 1500 includes providing (1520) the user request, the contextual data, and the contextual cues to an on-device ML (e.g., an on-device module on the head-wearable device 110). The method includes determining (1522) whether an off-device ML model selected. In accordance with a determination that an off-device module is not selected (“No” at operation 1522), the method 1500 returns to operations (1514) and (1518). In other words, the method 1500 generates the response locally and presents the locally generated response to the user request.

Alternatively, in accordance with a determination that an off-device module is selected (“Yes” at operation 1522), the method 1500 includes determining (1524) whether the off-device ML model needs an output of the on-device ML model. In accordance with a determination that the off-device ML model does not need an output of the on-device ML model (“No” at operation 1524), the method 1500 returns to operations (1514). The method 1500 further includes consolidating (1516) the responses received by the on-device ML model and the off-device module. Consolidating can include combining both response to generate a coherent response, removing duplicate information, validating response, expanding on the generated responses (e.g., linking the two or more responses to for a single coherent response, etc.). For example, as shown in FIG. 14, computing devices 1424 can provide generated response to the wearable device 1401 and the wearable device 1401 consolidated the responses generated by the computing devices 1424 with the responses generated locally (e.g., by computing elements 1420). The method 1500 further includes presenting (1518) a (consolidated) response to the user request. In other words, the method 1500 generates the response locally and presents the locally generated response to the user.

In accordance with a determination that the off-device ML model does need an output of the on-device ML model (“Yes” at operation 1524), the method 1500 includes providing (1526) the user request, the contextual data, the contextual cue, and an output of the on-device ML model to the off-device ML model. The method 1500 further returns and performs operations (1514), (1516), and (1518).

(A1) In accordance with some embodiments, a method is performed at a wearable device including an imaging device, a microphone, one or more sensors, a speaker, and a display. The method includes, in response to initiation of an artificially intelligent assistant, capturing contextual data. The contextual data includes one or more of image data and audio data. The method includes determining, based on the contextual data, a contextual cue, and providing a portion of the contextual data and a portion of the contextual cue to the artificially intelligent assistant. The method includes determining, by the artificially intelligent assistant, a user request based on the portion of the contextual data and the contextual cue, and receiving a response to the user request. The response is generated using a machine-learning model. The machine-learning model can be an MM-LLM, a lightweight MM-LLM, and/or another ML model. The method further includes causing the head-wearable device to present the response. Examples of the method are provided above in reference to FIGS. 1A-5B and 7-10D.

(A2) In some embodiments of A1, the response is one or more of a textual response, an audible response, and a visual response. In some embodiments, the response is notes, summaries, tags for handwritten notes, records, meeting notes, transcriptions, translations, etc.

(A3) In some embodiments of any one of A1-A2, the response includes identification of a target object and a follow-up action associated with the target object to be performed by the head-wearable device. In some embodiments, a target object is a textual, a visual, and/or an audible description of one or more of a scene, physical objects, text, sounds, or speech and the follow-up action, when selected by a user, cause the head-wearable device to perform sharing the target object, storing the target object, generating a reminder associated with the target object, performing a search based on the target object, extracting portions of the target object, editing the target object, and/or comparing the target object with at least one other object. Examples of the follow-up actions are provided above in reference to FIGS. 7-11.

(A4) In some embodiments of any one of A1-A3, the portion of the contextual data is formed by compressing the contextual data. Examples of compressing the contextual data are provided above in reference to the compression and transfer module 430; FIG. 4.

(A5) In some embodiments of any one of A1-A4, determining, based on the contextual data, the contextual cue includes determining a region of interest within the image data, the region of interest identifying a portion of the image data (including textual data) associated with the audio data; and cropping the image data based on the region of interest to form cropped image data. Examples of determining an ROI are provided above in reference to the STR module 435; FIG. 4.

(A6) In some embodiments of A5, determining, based on the contextual data, the contextual cue further includes detecting, based on the cropped image data, one or more of text and text locations (one or more of a word location, word order, paragraph location, and paragraph order); and determining one or more of a text and text order.

(A6.5) In some embodiments of any one of A1-A6, the machine-learning model is configured to determine a chain-of thought based on structured text (e.g., one or more of contextual data and contextual cues and/or one or more of processed contextual data and contextual cues).

(A7) In some embodiments of any one of A1-A6.5, the user request is a translation request; and the response generated by the machine-learning model is a translation of one or more of the portion of the contextual data and the contextual cue. Examples of translating using the AI assistant are provided above in reference to FIGS. 1A-4.

(A8) In some embodiments of any one of A1-A7, the machine-learning model is selected from a plurality of machine-learning models, and determining the user request based on the portion of the contextual data and the contextual cue further includes determining at least one machine-learning model from the plurality of machine learning models for generating the response based on the user request; selecting the at least one machine-learning model as the machine-learning model; and providing the user request and one or more of the portion of the contextual data and the contextual cue to the machine-learning model. In other words, as shown and described above in reference to FIGS. 4, 9, and 12-15B, different on-device and/or off-device modules or models can be selected to prepare a response to the user request.

(A9) In some embodiments of A8, the plurality of machine-learning models includes one or more of an on-device machine-learning model and a remote machine-learning model.

(A10) In some embodiments of any one of A1-A9, the contextual data includes sensor data and gestures. For example, the contextual data can include GPS data, biopotential signal data, eye-tracking data, and/or other sensors data.

(B1) Another method is performed at a wearable device including an imaging device, a microphone, a speaker, and a display. In some embodiments, the method includes, in response to a user input initiating an AI assistant, capturing, via the imaging device and/or the microphone, image data and/or audio data. The method includes, in response to capturing the image data and/or the audio data, compressing the image data to generate compressed image data, determining, based on the image data, at least text and text locations, and determining, based on the audio data, a user query. The compressed image data has a second resolution less than a first resolution of the image data. The method further includes providing, at least, the compressed image data, the text, the text location, and the user query to a server communicatively coupled with the wearable device.

(B2) In some embodiments of B1, determining the response to the prompt includes, generating, using the machine learning model, a textual response and an audible response based on the response to the prompt.

(B3) In some embodiments of B1-B2, compressing the image data includes determining a region of interest, the region of interesting identifying a portion of the image data including textual data associated with the user query, and cropping the image data based on the region of interest.

(B4) In some embodiments of B3, before determining the text and the text locations, updating the image data with the image data cropped based on the region of interest.

(B5) In some embodiments of B1-B4, the text locations include one or more of a word location, word order, paragraph location, and paragraph order.

(B6) In some embodiments of B1-B5, determining the text includes recognizing one or more words within the text.

(C1) In some embodiments, another method includes, in response to receiving, from a wearable device, compressed image data, the text, the text location, and the user query, generating, based on at least the text, the text location, and the user query, a prompt; providing the compressed image data and the prompt to a machine learning model that is configured to determine a response to the prompt; and providing the response to the prompt to the wearable device for presentation at the wearable device.

(C2) In some embodiments of B1, the other method is configured to perform operations in accordance with any of B2-B6.

(D1) In accordance with some embodiments, a non-transitory computer readable storage medium including instructions that, when executed by a computing device in communication with an artificial-reality headset, cause the computer device to perform operations corresponding to any of B1-B6.

(E1) In accordance with some embodiments, a method of operating a wearable device, including operations that correspond to any of B1-B6.

(F1) In accordance with some embodiments, a method of operating a server device, including operations that correspond to any of B1 and B2.

(G1) In accordance with some embodiments, a means for performing the operations that correspond to any of B1-B2.

(H1) In accordance with some embodiments, a system that includes one or more of a wearable devices and a server, and the system is configured to perform operations corresponding to any of B1-C2.

(I1) In some embodiments, a method includes, in response to a user input initiating an AI assistant, capturing, via the imaging device and/or the microphone, image data and/or audio data. The method includes determining based on the image data and/or the audio data, structured text representative of the image data and/or the audio data, and determining an inference of user intent based on the structured text. The method further includes generating target information and follow-up actions based on the inference of user intent and providing the target information and the follow-up actions to a user of an electronic device (e.g., a wearable device, a smartphone, and/or any other device described below in reference to FIGS. 16A-16-C2).

(I2) In some embodiments of H1, the target information is a textual, a visual, and/or an audible description of one or more of a scene, physical objects, text, sounds, or speech.

(I3) In some embodiments of H1-H2, the follow-up actions, when selected by a user, cause the wearable device perform or cause the performance of sharing the target information, storing the target information, generating a reminder associated with the target information, performing a search based on the target information, extracting portions of the target information, editing the target information, comparing the target information with at least one other object.

(I4) In some embodiments of H1-H3, determining the inference of user intent includes providing the structured text to a machine learning model, the machine learning model configured to determine a chain-of thought based on the structured text.

(I5) In some embodiments of H4, the machine learning model is a first machine learning model and generating the target information and the follow-up actions includes providing the inference of user intent to a second machine learning model, the machine learning model configured to predict the target information and the follow-up actions.

(I6) In some embodiments of H1-H5, the structured text includes one or more of a scene description, a physical object, visible text, acoustic sound, speech content, a place, and an activity.

(J1) In accordance with some embodiments, a non-transitory computer readable storage medium including instructions that, when executed by a computing device in communication with an artificial-reality headset, cause the computer device to perform operations corresponding to any of H1-H6.

(K1) In accordance with some embodiments, a method of operating a wearable device or electronic device, including operations that correspond to any of H1-H6.

(L1) In accordance with some embodiments, a method of operating a server device, including operations that correspond to any of H1-H6.

(M1) In accordance with some embodiments, a means for performing the operations that correspond to any of H1-H6.

(N1) In accordance with some embodiments, a system that includes one or more of a wearable devices and a server, and the system is configured to perform operations corresponding to any of H1-H6.

(O1) In accordance with some embodiments, a non-transitory computer readable storage medium including instructions that, when executed by a computing device in communication with an artificial-reality headset, cause the computer device to perform operations corresponding to any of A1-A10.

(P1) In accordance with some embodiments, a method of operating a wearable device or electronic device, including operations that correspond to any of A1-A10.

(Q1) In accordance with some embodiments, a method of operating a server device, including operations that correspond to any of A1-A10.

(R1) In accordance with some embodiments, a means for performing the operations that correspond to any of A1-A10.

(S1) In accordance with some embodiments, a system that includes one or more of a wearable devices and a server, and the system is configured to perform operations corresponding to any of A1-A10.

(T1) In accordance with some embodiments, a method includes, in response to a user input initiating an artificially intelligent (AI) assistant, capturing contextual data including one or more of image data and audio data and generating, based on the contextual data, user query data including a user query and a portion of the contextual data. The method also includes determining, using an AI assistant model that receives the user query data, a user prompt based on, at least the user query and the portion of the contextual data and generating, by the AI assistant model, a response to the user prompt. The method further incudes causing presentation of the response to the user prompt at a head-wearable device. For example, as described above in reference to FIG. 4, contextual data is processed to determine a response to be provided to a user associated with the head-wearable device. Example response to user prompts are shown and described above in reference to FIGS. 1A-3E.

(T2) In some embodiments of T1, the method includes detecting a region of interest within the contextual data, the region of interest identifying a portion of the image data including one or more of textual data or an object of interest associated with the user query. The method further includes compressing the region of interest within the contextual data to form the portion of the contextual data. The portion of the contextual data having a second resolution less than a first resolution of the contextual data. Additional information on identification of a region of interest and compression of image data can be found in at least the descriptions associated with FIGS. 3A-5B.

(T3) In some embodiments of T2, compressing the region of interest within the contextual data includes cropping the region of interest and removing portions of the image data not including the region of interest.

(T4) In some embodiments of any one of T1-T3, generating the user query data includes detecting, within the contextual data, one or more of a text, a text location, and the user query, and including the one or more of the text, the text location, and the user query in the user query data.

(T5) In some embodiments of T4, the text location includes one or more of a word location, word order, paragraph location, and/or paragraph order.

(T6) In some embodiments of any one of T4-T5, the user query is detected from the audio data in the contextual data.

(T7) In some embodiments of any one of T1-T6, the generation of the user query data is performed on-device.

(U1) In accordance with some embodiments, a method includes, in response to a user input initiating an artificially intelligent (AI) assistant, capturing contextual data including one or more of image data and audio data and generating, based on the contextual data, a structured textual representation of the contextual data. The method also includes determining, using an AI assistant model, a user prompt based on the structured textual representation of the contextual data; and generating, by the AI assistant model, a follow-up action to be performed on target information based on the user prompt. The method further includes causing presentation of the follow-up action at a head-wearable device. For example, as described above in reference to FIG. 9, audio data and/or image data captured by user of a wearable device can be used to generate follow-actions. As described above in reference to FIGS. 7 and 8, the follow-up actions can be based on historical user data (e.g., previous actions taken by a user for one or more situations). Example follow-up actions are shown and described in reference to FIGS. 10A-10D.

(U2) In some embodiments of U1, the target information is inferred, in part, from the structured textual representation of the contextual data.

(U3) In some embodiments of any one of U1-U2, the follow-up action is inferred, in part, from the structured textual representation of the contextual data.

(U4) In some embodiments of any one of U1-U3, the structured textual representation of the contextual data includes one or more of a textual representation of acoustic sound, a scene captured in image data, speech content, visible text, physical objects, a location, or an activity.

(U5) In some embodiments of any one of U1-U4, determining the user prompt based on the structured textual representation of the contextual data includes identifying one or more actions previously performed by a user associated with the head-wearable device, and selecting an action of the one or more actions previously performed by the user associated with the head-wearable device to determine the user prompt.

(U6) In some embodiments of U5, the one or more actions previously performed by the user associated with the head-wearable device are related to the contextual data.

(U7) In some embodiments of any one of U1-U6, the follow-up action includes one or more of sharing the target information, storing the target information, generating a reminder associated with the target information, performing a search based on the target information, extracting portions of the target information, editing the target information, comparing the target information with at least one other object. A non-exhaustive list of follow up actions is shown and described in reference to FIG. 11.

(V1) In accordance with some embodiments, a non-transitory computer readable storage medium including instructions that, when executed by a computing device in communication with head-wearable device, cause the computer device to perform operations corresponding to any of T1-U7.

(W1) In accordance with some embodiments, a method of operating a wearable device or electronic device, including operations that correspond to any of T1-U7.

(X1) In accordance with some embodiments, a method of operating a server device, including operations that correspond to any of T1-U7.

(Y1) In accordance with some embodiments, a means for performing the operations that correspond to any of T1-U7.

(Z1) In accordance with some embodiments, a system that includes one or more of a wearable devices and a server, and the system is configured to perform operations corresponding to any of T1-U7.

(AA1) In accordance with some embodiments, a wearable device (e.g., a head-wearable device, wrist-wearable device, etc.) that is configured to perform operations corresponding to any of T1-U7.

### Example Extended Reality Systems

FIGS. 16A, 16B, 16C-1, and 16C-2, illustrate example XR systems that include AR and MR systems, in accordance with some embodiments. FIG. 16A shows a first XR system 1600a and first example user interactions using a wrist-wearable device 1626, a head-wearable device (e.g., AR device 1628), and/or a handheld intermediary processing device (HIPD) 1642. FIG. 16B shows a second XR system 1600b and second example user interactions using a wrist-wearable device 1626, AR device 1628, and/or an HIPD 1642. FIGS. 16C-1 and 16C-2 show a third MR system 1600c and third example user interactions using a wrist-wearable device 1626, a head-wearable device (e.g., a mixed-reality device such as a virtual-reality (VR) device), and/or an HIPD 1642. As the skilled artisan will appreciate upon reading the descriptions provided herein, the above-example AR and MR systems (described in detail below) can perform various functions and/or operations.

The wrist-wearable device 1626, the head-wearable devices, and/or the HIPD 1642 can communicatively couple via a network 1625 (e.g., cellular, near field, Wi-Fi, personal area network, wireless LAN, etc.). Additionally, the wrist-wearable device 1626, the head-wearable devices, and/or the HIPD 1642 can also communicatively couple with one or more servers 1630, computers 1640 (e.g., laptops, computers, etc.), mobile devices 1650 (e.g., smartphones, tablets, etc.), and/or other electronic devices via the network 1625 (e.g., cellular, near field, Wi-Fi, personal area network, wireless LAN, etc.). Similarly, a smart textile-based garment, when used, can also communicatively couple with the wrist-wearable device 1626, the head-wearable device(s), the HIPD 1642, the one or more servers 1630, the computers 1640, the mobile devices 1650, and/or other electronic devices via the network 1625 to provide inputs.

Turning to FIG. 16A, a user 1602 is shown wearing the wrist-wearable device 1626 and the AR device 1628, and having the HIPD 1642 on their desk. The wrist-wearable device 1626, the AR device 1628, and the HIPD 1642 facilitate user interaction with an AR environment. In particular, as shown by the first AR system 1600a, the wrist-wearable device 1626, the AR device 1628, and/or the HIPD 1642 cause presentation of one or more avatars 1604, digital representations of contacts 1606, and virtual objects 1608. As discussed below, the user 1602 can interact with the one or more avatars 1604, digital representations of the contacts 1606, and virtual objects 1608 via the wrist-wearable device 1626, the AR device 1628, and/or the HIPD 1642. In addition, the user 1602 is also able to directly view physical objects in the environment, such as a physical table 1629, through transparent lens(es) and waveguide(s) of the AR device 1628. Alternatively, a MR device could be used in place of the AR device 1628 and a similar user experience can take place, but the user would not be directly viewing physical objects in the environment, such as table 1629, and would instead be presented with a virtual reconstruction of the table 1629 produced from one or more sensors of the MR device (e.g., an outward facing camera capable of recording the surrounding environment).

The user 1602 can use any of the wrist-wearable device 1626, the AR device 1628 (e.g., through physical inputs at the AR device and/or built in motion tracking of a user's extremities), a smart-textile garment, externally mounted extremity tracking device, the HIPD 1642 to provide user inputs, etc. For example, the user 1602 can perform one or more hand gestures that are detected by the wrist-wearable device 1626 (e.g., using one or more EMG sensors and/or IMUs built into the wrist-wearable device) and/or AR device 1628 (e.g., using one or more image sensors or cameras) to provide a user input. Alternatively, or additionally, the user 1602 can provide a user input via one or more touch surfaces of the wrist-wearable device 1626, the AR device 1628, and/or the HIPD 1642, and/or voice commands captured by a microphone of the wrist-wearable device 1626, the AR device 1628, and/or the HIPD 1642. The wrist-wearable device 1626, the AR device 1628, and/or the HIPD 1642 include an artificially intelligent (AI) digital assistant to help the user in providing a user input (e.g., completing a sequence of operations, suggesting different operations or commands, providing reminders, confirming a command). For example, the digital assistant can be invoked through an input occurring at the AR device 1628 (e.g., via an input at a temple arm of the AR device 1628). In some embodiments, the user 1602 can provide a user input via one or more facial gestures and/or facial expressions. For example, cameras of the wrist-wearable device 1626, the AR device 1628, and/or the HIPD 1642 can track the user 1602's eyes for navigating a user interface.

The wrist-wearable device 1626, the AR device 1628, and/or the HIPD 1642 can operate alone or in conjunction to allow the user 1602 to interact with the AR environment. In some embodiments, the HIPD 1642 is configured to operate as a central hub or control center for the wrist-wearable device 1626, the AR device 1628, and/or another communicatively coupled device. For example, the user 1602 can provide an input to interact with the AR environment at any of the wrist-wearable device 1626, the AR device 1628, and/or the HIPD 1642, and the HIPD 1642 can identify one or more back-end and front-end tasks to cause the performance of the requested interaction and distribute instructions to cause the performance of the one or more back-end and front-end tasks at the wrist-wearable device 1626, the AR device 1628, and/or the HIPD 1642. In some embodiments, a back-end task is a background-processing task that is not perceptible by the user (e.g., rendering content, decompression, compression, application-specific operations, etc.), and a front-end task is a user-facing task that is perceptible to the user (e.g., presenting information to the user, providing feedback to the user, etc.)). The HIPD 1642 can perform the back-end tasks and provide the wrist-wearable device 1626 and/or the AR device 1628 operational data corresponding to the performed back-end tasks such that the wrist-wearable device 1626 and/or the AR device 1628 can perform the front-end tasks. In this way, the HIPD 1642, which has more computational resources and greater thermal headroom than the wrist-wearable device 1626 and/or the AR device 1628, performs computationally intensive tasks and reduces the computer resource utilization and/or power usage of the wrist-wearable device 1626 and/or the AR device 1628.

In the example shown by the first AR system 1600a, the HIPD 1642 identifies one or more back-end tasks and front-end tasks associated with a user request to initiate an AR video call with one or more other users (represented by the avatar 1604 and the digital representation of the contact 1606) and distributes instructions to cause the performance of the one or more back-end tasks and front-end tasks. In particular, the HIPD 1642 performs back-end tasks for processing and/or rendering image data (and other data) associated with the AR video call and provides operational data associated with the performed back-end tasks to the AR device 1628 such that the AR device 1628 performs front-end tasks for presenting the AR video call (e.g., presenting the avatar 1604 and the digital representation of the contact 1606).

In some embodiments, the HIPD 1642 can operate as a focal or anchor point for causing the presentation of information. This allows the user 1602 to be generally aware of where information is presented. For example, as shown in the first AR system 1600a, the avatar 1604 and the digital representation of the contact 1606 are presented above the HIPD 1642. In particular, the HIPD 1642 and the AR device 1628 operate in conjunction to determine a location for presenting the avatar 1604 and the digital representation of the contact 1606. In some embodiments, information can be presented within a predetermined distance from the HIPD 1642 (e.g., within five meters). For example, as shown in the first AR system 1600a, virtual object 1608 is presented on the desk some distance from the HIPD 1642. Similar to the above example, the HIPD 1642 and the AR device 1628 can operate in conjunction to determine a location for presenting the virtual object 1608. Alternatively, in some embodiments, presentation of information is not bound by the HIPD 1642. More specifically, the avatar 1604, the digital representation of the contact 1606, and the virtual object 1608 do not have to be presented within a predetermined distance of the HIPD 1642. While an AR device 1628 is described working with an HIPD, a MR headset can be interacted with in the same way as the AR device 1628.

User inputs provided at the wrist-wearable device 1626, the AR device 1628, and/or the HIPD 1642 are coordinated such that the user can use any device to initiate, continue, and/or complete an operation. For example, the user 1602 can provide a user input to the AR device 1628 to cause the AR device 1628 to present the virtual object 1608 and, while the virtual object 1608 is presented by the AR device 1628, the user 1602 can provide one or more hand gestures via the wrist-wearable device 1626 to interact and/or manipulate the virtual object 1608. While an AR device 1628 is described working with a wrist-wearable device 1626, a MR headset can be interacted with in the same way as the AR device 1628.

### Integration of Artificial Intelligence with XR Systems

FIG. 16A illustrates an interaction in which an AI assistant (also referred to herein as a virtual assistant or AI assistant) can assist in requests made by a user 1602. The AI assistant can be used to complete open-ended requests made through natural language inputs by a user 1602. For example, FIG. 16A the user 1602 makes an audible request 1644 to summarize the conversation and then share the summarized conversation with others in the meeting. In addition, the AI assistant is configured to use sensors of the extended-reality system (e.g., cameras of an extended-reality headset, microphones, and various other sensors of any of the devices in the system) to provide contextual prompts to the user for initiating tasks. For example, a user may

FIG. 16A also illustrates an example neural network 1652 used in Artificial Intelligence applications. Uses of AI are varied and encompass many different aspects of the devices and systems described herein. AI capabilities cover a diverse range of applications and deepen interactions between the user 1602 and user devices (e.g., the AR device 1628, a MR device 1632, the HIPD 1642, the wrist-wearable device 1626, etc.). The AI discussed herein can be derived using many different training techniques. While the primary AI model example discussed herein is a neural network, other AI models can be used. Non-limiting examples of AI models include artificial neural networks (ANNs), deep neural networks (DNN), convolution neural networks (CNN), recurrent neural network (RNN), large language model (LLM), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AIs, depending on the task different models can be used. For example, for a natural language AI assistant a LLM can be used and for object detection of a physical environment a DNN can be used instead.

In another example, an AI assistant can include many different AI models and based on the user's request multiple AI models may be employed (concurrently, sequentially or a combination thereof). For example, a LLM based AI can provide instructions for helping a user follow a recipe and the instructions can be based in part on another AI that is derived from an ANN, a DNN, a RNN, etc. that is capable of discerning what part of the recipe the user is on (e.g., object and scene detection).

As artificial intelligence training models evolve, the operations and experiences described herein could potentially be performed with different models other than those listed above, and a person skilled in the art would understand that the list above is non-limiting.

A user 1602 can interact with an artificial intelligence through natural language inputs captured by a voice sensor, text inputs, or any other input modality that accepts natural language and/or a corresponding voice sensor module. In another instance, a user can provide an input by tracking an eye gaze of a user 1602 via a gaze tracker module. Additionally, the AI can also receive inputs beyond those supplied by a user 1602. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data, etc.) captured in response to a user request by various types of sensors and/or their corresponding sensor modules. The sensors data can be retrieved entirely from a single device (e.g., AR device 1628) or from multiple devices that are in communication with each other (e.g., a system that includes at least two of: an AR device 1628, a MR device 1632, the HIPD 1642, the wrist-wearable device 1626, etc.). The AI can also access additional information (e.g., one or more servers 1630, the computers 1640, the mobile devices 1650, and/or other electronic devices) via a network 1625.

A non-limiting list of AI enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI enhanced functions are fully or partially executed on cloud computing platforms communicatively coupled to the user devices (e.g., the AR device 1628, a MR device 1632, the HIPD 1642, the wrist-wearable device 1626, etc.) via the one or more networks. The cloud computing platforms provide scalable computing resources, distributed computing, managed AI services, interference acceleration, pre-trained models, application programming interface (APIs), and/or other resources to support comprehensive computations required by the AI enhanced function.

Example outputs stemming from the use of AI can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 1628, a MR device 1632, the HIPD 1642, the wrist-wearable device 1626, etc.), storages of the external devices (servers, computers, mobile devices, etc.), and/or storages of the cloud computing platforms.

The AI based outputs can be presented across different modalities (e.g., audio-based, visual-based, haptic-based, and any combination thereof) and across different devices of the XR system described herein. Some visual based outputs can include the displaying of information on XR augments of a XR headset, user interfaces displayed at a wrist-wearable device, laptop device, mobile device, etc. On devices with or without displays (e.g., HIPD 1642), haptic feedback can provide information to the user 1602. An artificial intelligence can also use the inputs described above to determine the appropriate modality and device(s) to present content to the user (e.g., a user walking on a busy road can be presented with an audio output instead of a visual output to avoid distracting the user 1602).

### Example Augmented-Reality Interaction

FIG. 16B shows the user 1602 wearing the wrist-wearable device 1626 and the AR device 1628, and holding the HIPD 1642. In the second AR system 1600b, the wrist-wearable device 1626, the AR device 1628, and/or the HIPD 1642 are used to receive and/or provide one or more messages to a contact of the user 1602. In particular, the wrist-wearable device 1626, the AR device 1628, and/or the HIPD 1642 detect and coordinate one or more user inputs to initiate a messaging application and prepare a response to a received message via the messaging application.

In some embodiments, the user 1602 initiates, via a user input, an application on the wrist-wearable device 1626, the AR device 1628, and/or the HIPD 1642 that causes the application to initiate on at least one device. For example, in the second AR system 1600b the user 1602 performs a hand gesture associated with a command for initiating a messaging application (represented by messaging user interface 1612); the wrist-wearable device 1626 detects the hand gesture; and, based on a determination that the user 1602 is wearing AR device 1628, causes the AR device 1628 to present a messaging user interface 1612 of the messaging application. The AR device 1628 can present the messaging user interface 1612 to the user 1602 via its display (e.g., as shown by user 1602's field of view 1610). In some embodiments, the application is initiated and can be run on the device (e.g., the wrist-wearable device 1626, the AR device 1628, and/or the HIPD 1642) that detects the user input to initiate the application, and the device provides another device operational data to cause the presentation of the messaging application. For example, the wrist-wearable device 1626 can detect the user input to initiate a messaging application, initiate and run the messaging application, and provide operational data to the AR device 1628 and/or the HIPD 1642 to cause presentation of the messaging application. Alternatively, the application can be initiated and run at a device other than the device that detected the user input. For example, the wrist-wearable device 1626 can detect the hand gesture associated with initiating the messaging application and cause the HIPD 1642 to run the messaging application and coordinate the presentation of the messaging application.

Further, the user 1602 can provide a user input provided at the wrist-wearable device 1626, the AR device 1628, and/or the HIPD 1642 to continue and/or complete an operation initiated at another device. For example, after initiating the messaging application via the wrist-wearable device 1626 and while the AR device 1628 presents the messaging user interface 1612, the user 1602 can provide an input at the HIPD 1642 to prepare a response (e.g., shown by the swipe gesture performed on the HIPD 1642). The user 1602's gestures performed on the HIPD 1642 can be provided and/or displayed on another device. For example, the user 1602's swipe gestures performed on the HIPD 1642 are displayed on a virtual keyboard of the messaging user interface 1612 displayed by the AR device 1628.

In some embodiments, the wrist-wearable device 1626, the AR device 1628, the HIPD 1642, and/or other communicatively coupled devices can present one or more notifications to the user 1602. The notification can be an indication of a new message, an incoming call, an application update, a status update, etc. The user 1602 can select the notification via the wrist-wearable device 1626, the AR device 1628, or the HIPD 1642 and cause presentation of an application or operation associated with the notification on at least one device. For example, the user 1602 can receive a notification that a message was received at the wrist-wearable device 1626, the AR device 1628, the HIPD 1642, and/or other communicatively coupled device and provide a user input at the wrist-wearable device 1626, the AR device 1628, and/or the HIPD 1642 to review the notification, and the device detecting the user input can cause an application associated with the notification to be initiated and/or presented at the wrist-wearable device 1626, the AR device 1628, and/or the HIPD 1642.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1628 can present to the user 1602 game application data and the HIPD 1642 can use a controller to provide inputs to the game. Similarly, the user 1602 can use the wrist-wearable device 1626 to initiate a camera of the AR device 1628, and the user can use the wrist-wearable device 1626, the AR device 1628, and/or the HIPD 1642 to manipulate the image capture (e.g., zoom in or out, apply filters, etc.) and capture image data.

While an AR device 1628 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing LED(s) configured to provide a user with information, e.g., a LED around the right-side lens can illuminate to notify the wearer to turn right while directions are being provided or a LED on the left-side can illuminate to notify the wearer to turn left while directions are being provided. In another embodiment, the AR device can include an outward facing projector such that information (e.g., text information, media, etc.) may be displayed on the palm of a user's hand or other suitable surface (e.g., a table, whiteboard, etc.). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce binocular image). In some instances, an AR device capable of presenting AR augments binocularly can optionally display AR augments monocularly as well (e.g., for power saving purposes or other presentation considerations). These examples are non-exhaustive and features of one AR device described above can combined with features of another AR device described above. While features and experiences of an AR device have been described generally in the preceding sections, it is understood that the described functionalities and experiences can be applied in a similar manner to a MR headset, which is described below in the proceeding sections.

### Example Mixed-Reality Interaction

Turning to FIGS. 16C-1 and 16C-2, the user 1602 is shown wearing the wrist-wearable device 1626 and a MR device 1632 (e.g., a device capable of providing either an entirely virtual reality (VR) experience or a mixed reality experience that displays object(s) from a physical environment at a display of the device), and holding the HIPD 1642. In the third AR system 1600c, the wrist-wearable device 1626, the MR device 1632, and/or the HIPD 1642 are used to interact within an MR environment, such as a VR game or other MR/VR application. While the MR device 1632 present a representation of a VR game (e.g., first MR game environment 1620) to the user 1602, the wrist-wearable device 1626, the MR device 1632, and/or the HIPD 1642 detect and coordinate one or more user inputs to allow the user 1602 to interact with the VR game.

In some embodiments, the user 1602 can provide a user input via the wrist-wearable device 1626, the MR device 1632, and/or the HIPD 1642 that causes an action in a corresponding MR environment. For example, the user 1602 in the third MR system 1600c (shown in FIG. 16C-1) raises the HIPD 1642 to prepare for a swing in the first MR game environment 1620. The MR device 1632, responsive to the user 1602 raising the HIPD 1642, causes the MR representation of the user 1622 to perform a similar action (e.g., raise a virtual object, such as a virtual sword 1624). In some embodiments, each device uses respective sensor data and/or image data to detect the user input and provide an accurate representation of the user 1602's motion. For example, image sensors (e.g., SLAM cameras or other cameras) of the HIPD 1642 can be used to detect a position of the HIPD 1642 relative to the user 1602's body such that the virtual object can be positioned appropriately within the first MR game environment 1620; sensor data from the wrist-wearable device 1626 can be used to detect a velocity at which the user 1602 raises the HIPD 1642 such that the MR representation of the user 1622 and the virtual sword 1624 are synchronized with the user 1602's movements; and image sensors of the MR device 1632 can be used to represent the user 1602's body, boundary conditions, or real-world objects within the first MR game environment 1620.

In FIG. 16C-2, the user 1602 performs a downward swing while holding the HIPD 1642. The user 1602's downward swing is detected by the wrist-wearable device 1626, the MR device 1632, and/or the HIPD 1642 and a corresponding action is performed in the first MR game environment 1620. In some embodiments, the data captured by each device is used to improve the user's experience within the MR environment. For example, sensor data of the wrist-wearable device 1626 can be used to determine a speed and/or force at which the downward swing is performed and image sensors of the HIPD 1642 and/or the MR device 1632 can be used to determine a location of the swing and how it should be represented in the first MR game environment 1620, which, in turn, can be used as inputs for the MR environment (e.g., game mechanics, which can use detected speed, force, locations, and/or aspects of the user 1602's actions to classify a user's inputs (e.g., user performs a light strike, hard strike, critical strike, glancing strike, miss) or calculate an output (e.g., amount of damage)).

FIG. 16C-2 further illustrates that a portion of the physical environment is reconstructed and displayed at a display of the MR device 1632 while the MR game environment 1620 is being displayed. In this instance, a reconstruction of the physical environment 1646 is displayed in place of a portion of the MR game environment 1620 when object(s) in the physical environment are potentially in the path of the user (e.g., a collision with the user and an object in the physical environment are likely). Thus, this example MR game environment 1620 includes (i) an immersive virtual reality portion 1648 (e.g., an environment that does not have corollary counterpart in a nearby physical environment) and (ii) a reconstruction of the physical environment 1646 (e.g., table 1651 and cup 1653). While the example shown here is a MR environment that shows a reconstruction of the physical environment to avoid collisions, other uses of reconstructions of the physical environment can be used, such as defining features of the virtual environment based on the surrounding physical environment (e.g., a virtual column can be placed based an object in the surrounding physical environment (e.g., a tree)).

While the wrist-wearable device 1626, the MR device 1632, and/or the HIPD 1642 are described as detecting user inputs, in some embodiments, user inputs are detected at a single device (with the single device being responsible for distributing signals to the other devices for performing the user input). For example, the HIPD 1642 can operate an application for generating the first MR game environment 1620 and provide the MR device 1632 with corresponding data for causing the presentation of the first MR game environment 1620, as well as detect the 1602's movements (while holding the HIPD 1642) to cause the performance of corresponding actions within the first MR game environment 1620. Additionally, or alternatively, in some embodiments, operational data (e.g., sensor data, image data, application data, device data, and/or other data) of one or more devices is provide to a single device (e.g., the HIPD 1642) to process the operational data and cause respective devices to perform an action associated with processed operational data.

In some embodiments, the user 1602 can wear a wrist-wearable device 1626, wear a MR device 1632, wear a smart textile-based garments 1638 ((e.g., wearable haptic gloves), and/or hold an HIPD 1642 device. In this embodiment, the wrist-wearable device 1626, the MR device 1632, and/or the smart textile-based garments 1638 are used to interact within an MR environment (e.g., any AR or MR system described above in reference to FIGS. 16A-16B). While the MR device 1632 presents a representation of a MR game (e.g., second MR game environment 1620) to the user 1602, the wrist-wearable device 1626, the MR device 1632, and/or the smart textile-based garments 1638 detect and coordinate one or more user inputs to allow the user 1602 to interact with the MR environment.

In some embodiments, the user 1602 can provide a user input via the wrist-wearable device 1626, a HIPD 1642, the MR device 1632, and/or the smart textile-based garments 1638 that causes an action in a corresponding MR environment. For example, the user 1602. In some embodiments, each device uses respective sensor data and/or image data to detect the user input and provide an accurate representation of the user 1602's motion. While four different input devices are shown (e.g., a wrist-wearable device 1626, a MR device 1632, a HIPD 1642, and a smart textile-based garment 1638) each one of these input devices entirely on their own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 1638) sensor fusion can be utilized to ensure inputs are correct. While multiple input devices are described, it is understood other input devices can be used in conjunction or on their own instead, such as but not limited to external motion tracking cameras, other wearable devices fitted to different parts of a user, apparatuses that allow for a user to experience walking in a MR while remaining substantially stationary in the physical environment, etc.

As described above, the data captured by each device is used to improve the user's experience within the MR environment. Although not shown, the smart textile-based garments 1638 can be used in conjunction with an MR device and/or an HIPD 1642.

While some experiences are described as occurring on an AR device and other experiences described as occurring on a MR device, one skilled in the art would appreciate that experiences can be ported over from a MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 16A-16C-2 provided above are intended to augment the description provided in reference to FIGS. 1A-15B. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer readable storage medium including instructions that, when executed by a head-wearable device, cause the head-wearable device to perform:
in response to a user input initiating an artificially intelligent (AI) assistant, capturing contextual data including one or more of image data and audio data;
generating, based on the contextual data, user query data including a user query and a portion of the contextual data;
determining, using an AI assistant model that receives the user query data, a user prompt based on, at least the user query and the portion of the contextual data;
generating, by the AI assistant model, a response to the user prompt; and
causing presentation of the response to the user prompt at the head-wearable device.

2. The non-transitory computer readable storage medium of claim 1, wherein the instructions, when executed by the head-wearable device, further cause the head-wearable device to perform:
detecting a region of interest within the contextual data, the region of interest identifying a portion of the image data including one or more of textual data or an object of interest associated with the user query; and
compressing the region of interest within the contextual data to form the portion of the contextual data, the portion of the contextual data having a second resolution less than a first resolution of the contextual data.

3. The non-transitory computer readable storage medium of claim 2, wherein compressing the region of interest within the contextual data includes:
cropping the region of interest; and
removing portions of the image data not including the region of interest.

4. The non-transitory computer readable storage medium of claim 1, wherein generating the user query data includes:
detecting, within the contextual data, one or more of a text, a text location, and the user query; and
including the one or more of the text, the text location, and the user query in the user query data.

5. The non-transitory computer readable storage medium of claim 4, wherein the text location includes one or more of a word location, word order, paragraph location, or paragraph order.

6. The non-transitory computer readable storage medium of claim 4, wherein the user query is detected from the audio data in the contextual data.

7. The non-transitory computer readable storage medium of claim 1, wherein generation of the user query data is performed on-device.

8. A head-wearable device, comprising:
one or more sensors; and
one or more processors configured to execute instructions for causing performance of:
in response to a user input initiating an artificially intelligent (AI) assistant, capturing contextual data including one or more of image data and audio data;
generating, based on the contextual data, user query data including a user query and a portion of the contextual data;
determining, using an AI assistant model that receives the user query data, a user prompt based on, at least the user query and the portion of the contextual data;
generating, by the AI assistant model, a response to the user prompt; and
causing presentation of the response to the user prompt at the head-wearable device.

9. The head-wearable device of claim 8, wherein the instructions, when executed by the one or more processors, further cause the performance of:
detecting a region of interest within the contextual data, the region of interest identifying a portion of the image data including one or more of textual data or an object of interest associated with the user query; and
compressing the region of interest within the contextual data to form the portion of the contextual data, the portion of the contextual data having a second resolution less than a first resolution of the contextual data.

10. The head-wearable device of claim 9, wherein compressing the region of interest within the contextual data includes:
cropping the region of interest; and
removing portions of the image data not including the region of interest.

11. The head-wearable device of claim 8, wherein generating the user query data includes:
detecting, within the contextual data, one or more of a text, a text location, and the user query; and
including the one or more of the text, the text location, and the user query in the user query data.

12. The head-wearable device of claim 11, wherein the text location includes one or more of a word location, word order, paragraph location, or paragraph order.

13. The head-wearable device of claim 11, wherein the user query is detected from the audio data in the contextual data.

14. The head-wearable device of claim 8, wherein generation of the user query data is performed on-device.

15. A method, comprising:
in response to a user input initiating an artificially intelligent (AI) assistant, capturing contextual data including one or more of image data and audio data;
generating, based on the contextual data, user query data including a user query and a portion of the contextual data;
determining, using an AI assistant model that receives the user query data, a user prompt based on, at least the user query and the portion of the contextual data;
generating, by the AI assistant model, a response to the user prompt; and
causing presentation of the response to the user prompt at a head-wearable device.

16. The method of claim 15, further comprising:
detecting a region of interest within the contextual data, the region of interest identifying a portion of the image data including one or more of textual data or an object of interest associated with the user query; and
compressing the region of interest within the contextual data to form the portion of the contextual data, the portion of the contextual data having a second resolution less than a first resolution of the contextual data.

17. The method of claim 16, wherein compressing the region of interest within the contextual data includes:
cropping the region of interest; and
removing portions of the image data not including the region of interest.

18. The method of claim 16, wherein generating the user query data includes:
detecting, within the contextual data, one or more of a text, a text location, and the user query; and
including the one or more of the text, the text location, and the user query in the user query data.

19. The method of claim 18, wherein the text location includes one or more of a word location, word order, paragraph location, or paragraph order.

20. The method of claim 15, wherein generation of the user query data is performed on-device.
